(19) United States
(12) Patent Application Publication
(10) Pub. No.: US 2015/0130916 A1
(43) Pub. Date: May 14, 2015

(54) THREE-DIMENSIONAL IMAGE DISPLAY DEVICE

(71) Applicant: SAMSUNG DISPLAY CO., LTD., YONGIN-CITY (KR)

(72) Inventors: GORO HAMAGISHI, HWASEONG-SI (KR); SE HUHN HUR, YONGIN-SI (KR); SEON KI KIM, YONGIN-SI (KR); KYUNG HO JUNG, SEONGNAM-SI (KR)

(73) Assignee: SAMSUNG DISPLAY CO., LTD., YONGIN-CITY (KR)

(21) Appl. No.: 14/272,096

(22) Filed: May 7, 2014

(30) Foreign Application Priority Data
Nov. 13, 2013 (KR) 10-2013-0137825

(51) Int. Cl. H04N 13/04

(52) U.S. Cl. CPC H04N 13/0404
USPC 348/59

(57) ABSTRACT

An autostereoscopic 3D image display device includes: a display panel that includes a plurality of pixels arranged in a matrix; and a view point divider that divides a three-dimensional image displayed by the display panel into n view points, where n is a natural number>=two, and includes a plurality of view point division units. Each view point division unit is inclined with an inclination angle with reference to a column direction of the display panel. The inclination angle satisfies

$$A = {tan}^{- 1} \frac{Hp \times a}{Vp \times b} , \\ 1 < a < b ,$$

where Hp is a pitch of a row direction of the pixels, Vp is a pitch of a column direction of the pixels, and a and b are natural numbers.

### CROSS-REFERENCE TO RELATED APPLICATION

This application claims priority from Korean Patent Application No. 10-2013-0137825 filed in the Korean Intellectual Property Office on Nov. 13, 2013, and all the benefits accruing therefrom, the contents of which are herein incorporated by reference in their entirety.

### BACKGROUND

(a) Technical Field

Embodiments of the present disclosure are directed to a three-dimensional (3D) image display device, and in particular, to an autostereoscopic 3D image display device.

(b) Discussion of the Related Art

With the development of display device technology, three-dimensional (3D) image display devices have recently received attention, and various methods of displaying a 3D image have been studied.

In general, a 3D image display technology represents objects hi 3D using binocular parallax, which is the mechanism for visualizing objects in 3D at short distances. That is, different 2D images are projected to the left eye and the right eye, and when the image projected to the left eye (hereafter referred to as a “left eye image”) and the image projected to the right eye (hereafter referred to as a “right eye image”) are transmitted to the brain, the left eye image and the right eye image are converged by the brain to be perceived as a 3D image having depth.

3D image display devices include a stereoscopic type 3D image display device, which uses glasses such as shutter glasses or polarized glasses, and an autostereoscopic type 3D image display device, which uses an optical system such as a lenticular lens or a parallax barrier in the display device, not glasses.

An autostereoscopic type displays a three-dimensional image by dividing it into several viewpoints using a lenticular lens or a parallax barrier that has a plurality of openings, thereby produce a three-dimensional image.

### SUMMARY

Exemplary embodiments of the present disclosure can prevent a moiré pattern and improve a display quality in an autostereoscopic 3D image display device.

A three-dimensional image display device according to an exemplary embodiment of the present disclosure includes: a display panel that includes a plurality of pixels arranged in a matrix form; and a view point divider that divides a three-dimensional image displayed by the display panel into n view points, where n is a natural number greater than or equal to two, and that includes a plurality of view point division units, wherein each view point division unit is inclined at an inclination angle with reference to a column direction of the display panel, the inclination angle satisfies

$$A = {tan}^{- 1} \frac{Hp \times a}{Vp \times b} , \\ 1 < a < b ,$$

wherein Hp is a pitch of a row direction of the pixels, Vp is a pitch of a column direction of the pixels, and a and b are natural numbers.

Each pixel may may represent one color of a plurality of primary colors. A width of the row direction of a region of a first pixel observed through the view point division unit may m×Hp/b, wherein m is a natural number, and a second pixel next to the first pixel displayed by the same view point division unit as the first pixel displays the image at the same view point of the first pixel and is offset downward from the first pixel by b columns.

The plurality of view point division units may include a plurality of lenticular lenses.

A focal distance F of the lenticular lens may satisfy 1/D+1/G≠1/F, wherein D is an optimal viewing distance from the view point divider for viewing the image of the display panel, and G is a distance between the lenticular lens and the display panel.

If a focus position of the lenticular lens is positioned between the lenticular lens and the display panel, a focal distance Fs of the lenticular lens may satisfy 1/D+(b*L+Hp)/b*L*G=1/Fs, wherein L is a pitch of the lenticular lens

If a focus position of the lenticular lens is positioned outside an area between the lenticular lens and the display panel, a focal distance FL of the lenticular lens may satisfy 1/D+(b*L−Hp)/b*L*G=1/FL, wherein L is a pitch of the lenticular lens.

Herein, it may be that a=2 and b=3.

Herein, it may be that a=3 and b=4.

Herein, it may be that m=1.

The view point divider may include a parallax barrier, and the view point division unit may include a plurality of openings of the parallax barrier arranged in a line.

The plurality of openings arranged in the line may be inclined at the inclination angle.

A width W of the row direction of the opening may satisfy W=D*X/(D+G), where X=m*Hp/b, D is an optimal viewing distance from the view point divider for viewing the image of the display panel, and G is a distance between the parallax barrier and the display panel.

Herein, m may be 1 or 2.

A three-dimensional image display device according to another exemplary embodiment of the present disclosure includes: a display panel that includes a plurality of pixels arranged in a matrix form wherein each pixel represents one color of a plurality of primary colors, and a view point divider configured to divide a three-dimensional image displayed by the display panel into n view points, wherein n is a natural number greater than or equal to two and the view point divider includes a plurality of lenticular lenses, wherein a focal distance F of the lenticular lens satisfies 1/D+1/G≠1/F, wherein D is an optimal viewing distance from the view point divider for viewing the image of the display panel, and G is a distance between the lenticular lens and the display panel, wherein a width of the row direction of a region of a first pixel observed through the lenticular lens is m×Hp/b, wherein Hp is a pitch of a row direction of the pixels and b and m are natural numbers, and a second pixel next to the first pixel displayed by the same view point division unit as the first pixel displays the image at the same view point of the first pixel and is offset downward from the first pixel by b columns.

Each lenticular lens may be inclined at an inclination angle with reference to a column direction of the display panel, the inclination angle satisfies

$$A = {tan}^{- 1} \frac{Hp \times a}{Vp \times b} , \\ 1 < a < b ,$$

wherein Vp is a pitch of a column direction of the pixels, and a and b are natural numbers.

If a focus position of the lenticular lens is positioned between the lenticular lens and the display panel, a focal distance Fs of the lenticular lens satisfies 1/D+(b*L+Hp)/b*L*G=1/Fs, wherein L is a pitch of the lenticular lens.

If a focus position of the lenticular lens is positioned outside an area between the lenticular lens and the display panel, a focal distance FL of the lenticular lens satisfies 1/D+(b*L−Hp)/b*L*G=1/FL, wherein L is a pitch of the lenticular lens.

A three-dimensional image display device according to another exemplary embodiment of the present disclosure includes: a display panel that includes a plurality of pixels arranged in a matrix form each pixel represents one color of a plurality of primary colors, and a view point divider configured to divide a three-dimensional image displayed by the display panel into n view points, wherein n is a natural number greater than or equal to two and the view point divider includes a parallax barrier that includes a plurality of openings arranged in a line, wherein a width W of each opening satisfies W=D×X/(D+G), wherein Hp is a pitch of a row direction of the pixels, D is an optimal viewing distance from the view point divider for viewing the image of the display panel, G is a distance between the parallax barrier and the display panel, where X=m×Hp/b, wherein b and m are natural numbers, wherein a width of the row direction of a region of a first pixel observed through the lenticular lens is X, and a second pixel next to the first pixel displayed by the same view point division unit as the first pixel displays the image at the same view point of the first pixel and is offset downward from the first pixel by b columns.

Each of plurality of openings is inclined at an inclination angle with reference to a column direction of the display panel, the inclination angle satisfies

$$A = {tan}^{- 1} \frac{Hp \times a}{Vp \times b} , \\ 1 < a < b ,$$

wherein Vp is a pitch of a column direction of the pixels, and a and b are natural numbers.

According to an exemplary embodiment of the present disclosure, in the autostereoscopic three-dimensional image display device, a moiré pattern may be prevented regardless of the viewing position, and an overall display quality may be improved.

### BRIEF DESCRIPTION OF THE DRAWINGS

FIG. 1 is a schematic perspective view of a three-dimensional image display device according to an exemplary embodiment of the present disclosure.

FIG. 2 is a lateral perspective view of a three-dimensional image display device according to an exemplary embodiment of the present disclosure.

FIG. 3 and FIG. 4 show a view point divider and a view point by a view point divider of a three-dimensional image display device according to an exemplary embodiment of the present disclosure.

FIG. 5 shows an inclination angle of a view point division unit for a display panel of a three-dimensional image display device according to an exemplary embodiment of the present disclosure.

FIG. 6 shows a region of a display panel enlarged or transmitted by one lenticular lens or opening of a view point divider of a three-dimensional image display device according to an exemplary embodiment of the present disclosure.

FIG. 7 to FIG. 10 show a region of a display panel enlarged or transmitted by one lenticular lens or opening of a view point divider of a three-dimensional image display device according to an exemplary embodiment of the present disclosure when a view point division unit is inclined at a specific inclination angle.

FIG. 11 and FIG. 12 show a design condition of a view point divider when a lenticular lens is included in the view point divider of a three-dimensional image display device according to an exemplary embodiment of the present disclosure.

FIG. 13 show a design condition of a view point divider when a parallax barrier is included in the view point divider of a three-dimensional image display device according to an exemplary embodiment of the present disclosure.

FIG. 14 and FIG. 15 show a region of a display panel transmitted through an opening of a parallax barrier when a parallax barrier is included in a view point divider of a three-dimensional image display device according to an exemplary embodiment of the present disclosure.

FIG. 16 shows a plurality of inclination angles of a view point division unit for a display panel of a three-dimensional image display device according to an exemplary embodiment of the present disclosure.

FIG. 17 is a table of several display qualities as a function of inclination angles of a view point division unit of a three-dimensional image display device according to an exemplary embodiment of the present disclosure.

FIG. 18 to FIG. 23 show a proximity pixel that represents corresponding crosstalk for several inclination angles of a view point division unit of a three-dimensional image display device according to an exemplary embodiment of the present disclosure.

FIG. 24 and FIG. 25 show a method of calculating crosstalk for an inclination angle of a three-dimensional image display device according to an exemplary embodiment of the present disclosure.

FIG. 26 shows pixels that represent an image observed at any one view point through a view point divider of a three-dimensional image display device according to an exemplary embodiment of the present disclosure.

FIG. 27 shows an image actually observed through the view point divider for an image displayed by pixels shown in FIG. 26.

FIG. 28 shows a region of a display panel enlarged or transmitted by a view point divider of a three-dimensional image display device according to the exemplary embodiment shown in FIG. 26 and FIG. 27.

FIG. 29 shows pixels that represent an image observed at any one view point through a view point divider of a three-dimensional image display device according to an exemplary embodiment of the present disclosure.

FIG. 30 shows an image actually observed through a view point divider for an image displayed by pixels shown in FIG. 29.

FIG. 31 shows a region of a display panel enlarged or transmitted by a view point divider of a three-dimensional image display device according to the exemplary embodiment shown in FIG. 29 and FIG. 30.

FIG. 32 shows pixels that represent an image observed at any one view point through a view point divider of a three-dimensional image display device according to an exemplary embodiment of the present disclosure.

FIG. 33 shows an image actually observed through a view point divider for an image displayed by pixels shown in FIG. 32.

FIG. 34 shows a region of a display panel enlarged or transmitted by a view point divider of a three-dimensional image display device according to the exemplary embodiment shown in FIG. 32 and FIG. 33.

FIG. 35 shows pixels that represent an image observed at any one view point through a view point divider of a three-dimensional image display device according to an exemplary embodiment of the present disclosure.

FIG. 36 is a view showing an image actually observed through a view point divider for an image displayed by pixels shown in FIG. 35,

FIG. 37 is a view showing a region of a display panel enlarged or transmitted by a view point divider of a three-dimensional image display device according to the exemplary embodiment shown in FIG. 35 and FIG. 36,

FIG. 38 is a view showing pixels representing an image observed at any one view point through a view point divider of a three-dimensional image display device according to an exemplary embodiment of the present disclosure,

FIG. 39 shows an image actually observed through a view point divider for an image displayed by pixels shown in FIG. 38.

FIG. 40 shows a region of a display panel enlarged or transmitted by a view point divider of a three-dimensional image display device according to the exemplary embodiment shown in FIG. 38 and FIG. 39.

FIG. 41 shows pixels that represent an image observed at any one view point through a view point divider of a three-dimensional image display device according to an exemplary embodiment of the present disclosure.

FIG. 42 shows an image actually observed through a view point divider for an image displayed by pixels shown in FIG. 41.

FIG. 43 shows a region of a display panel enlarged or transmitted by a view point divider of a three-dimensional image display device according to the exemplary embodiment shown in FIG. 41 and FIG. 42.

FIG. 44 shows pixels that represent an image observed at any one view point through a view point divider of a three-dimensional image display device according to an exemplary embodiment of the present disclosure.

FIG. 45 shows an image actually observed through a view point divider for an image displayed by pixels shown in FIG. 44.

FIG. 46 shows a region of a display panel enlarged or transmitted by a view point divider of a three-dimensional image display device according to the exemplary embodiment shown in FIG. 44 and FIG. 45.

FIG. 47 and FIG. 48 show several inclination angles of a view point division unit with respect to a display panel of a three-dimensional image display device according to an exemplary embodiment of the present disclosure.

FIG. 49 shows the primary color image observed at one view point for each view point division unit inclination angle shown in FIG. 48.

FIG. 50 and FIG. 51 show crosstalk for two inclination angles of a view point division unit with respect to a display panel of a three-dimensional image display device according to an exemplary embodiment of the present disclosure.

FIG. 52 shows a change of a proximity pixel as a function of a change of position for observing a three-dimensional image display device according to an exemplary embodiment of the present disclosure.

### DETAILED DESCRIPTION OF EXEMPLARY EMBODIMENTS

Exemplary embodiments of the present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

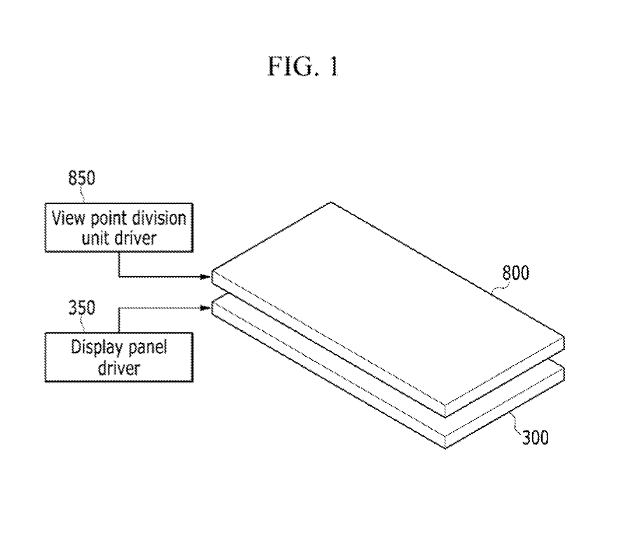

First, a three-dimensional image display device according to an exemplary embodiment of the present disclosure will be described with reference to FIG. 1 to FIG. 10.

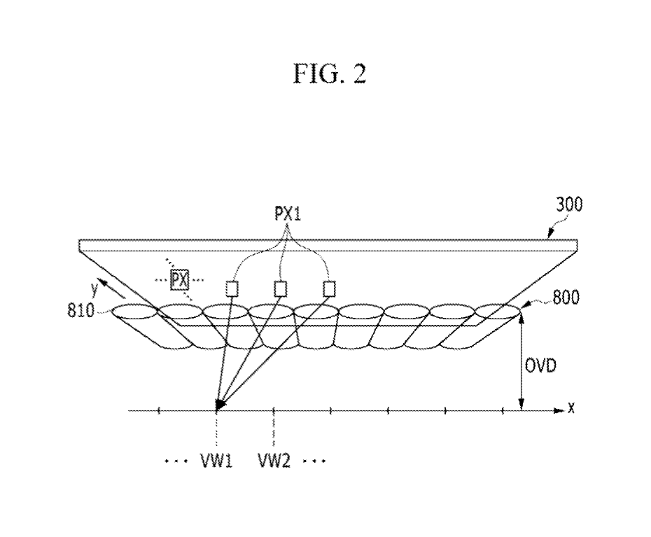

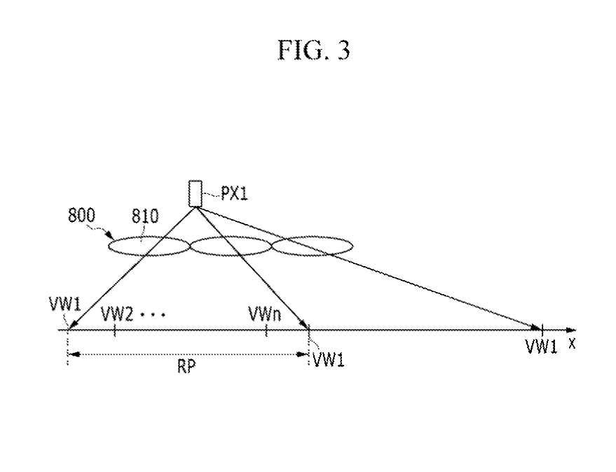

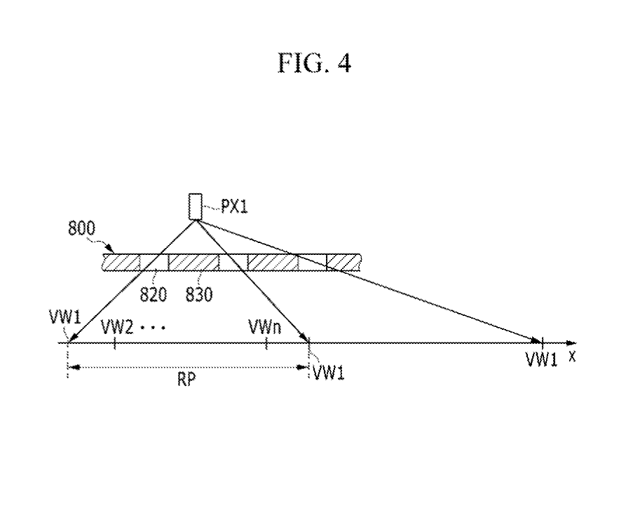

FIG. 1 is a schematic perspective view of a three-dimensional image display device according to an exemplary embodiment of the present disclosure, FIG. 2 is a lateral perspective view of a three-dimensional image display device according to an exemplary embodiment of the present disclosure, and FIG. 3 and FIG. 4 show a view point divider and a view point by a view point divider of a three-dimensional image display device according to an exemplary embodiment of the present disclosure.

Referring to FIG. 1, a three-dimensional image display device according to an exemplary embodiment of the present disclosure includes a display panel 300, a display panel driver 350, a view point divider 800, and a view point division unit driver 850.

The display panel 300 displays an image, and may be one of various display devices such as a plasma display panel (PDP), a liquid crystal display (LCD), or an organic light emitting diode (OLED) display.

Referring to FIG. 2, the display panel 300 includes a plurality of signal lines and a plurality of pixels PX connected to the signal lines. The plurality of pixels PX may be arranged in a substantially matrix form. In FIG. 2, a row direction may be indicated by an x-axis direction, and a column direction may be indicated by a y-axis direction. Each pixel PX may include a switching element such as a thin film transistor connected to the signal lines and a pixel electrode connected thereto. The signal lines include a plurality of gate lines that transfer gate signals (referred to as “scanning signals”) and a plurality of data lines that transfer data voltages.

Each pixel PX may display one primary color in a spatial division mode or may alternately display each primary color over time in a temporal division mode, and as a result, a desired color may be displayed by the spatial and temporal sum of the primary colors. The primary colors may be one of various combinations that include either three primary colors or four primary colors, however the three primary colors of red (R), green (G), and blue (B) are described as a non-limiting example in a present exemplary embodiment. A set pixels PX that together display the different primary colors may configure one dot. One dot of a display unit of the three-dimensional image may display white. The pixels PX of one pixel column may represent the same primary color, however embodiments of the present disclosure are not limited thereto, and pixels PX arranged along a diagonal of a predetermined angle may display the same primary color.

The display panel driver 350 can transmit various driving signals such as a gate signal and a data signal to the display panel 300 to drive the display panel 300.

Referring to FIG. 2, the view point divider 800 divides and transmits light of an image emitted by the pixel PX of the display panel 300 to view points VW1, VW2, . . . corresponding to each pixel PX. Let a distance between the 3D image display device and a point from which an optimal 3D image can be viewed be called an optimal viewing distance OVD, and let an x-axis coordinate of the point at the optimal viewing distance OVD reached by light emitted by each pixel PX be called a view point. According to an exemplary embodiment of the present disclosure, each pixel PX of the display panel 300 corresponds to a single view point VW1, VW2, . . . , and each pixel PX may emit light to the corresponding view point VW1, VW2, . . . through the view point divider 800. A viewer views a different image through each respective eye at different view points, and thus may perceive depth, that is, a 3D effect.

FIG. 2 illustrates a finite number of view points VW1, VW2, . . . positioned at the optimal viewing distance OVD as a non-limiting example. For example, let a view point from which an image displayed by a first pixel PX1 is viewed be a first view point VW1; the light emitted by each first pixel PX1 may reach the first view point VW1 through the view point divider 800.

Referring to FIG. 3 and FIG. 4, the image displayed by the display panel 300 may reach one of the view points VW1-VWn (n is a natural number) of a unit view area RP having a predetermined viewing angle through the view point divider 800. That is, the view points VW1-VWn are part of a unit view area RP, and a view point corresponding to each pixel PX may be allocated according to a position in the unit view area RP reached by light emitted by the pixel. A unit view area RP may be periodically repeated along the x-axis at the optimal viewing distance OVD, and each unit view area RP may include a sequence of view points VW1-VWn.

Referring to FIG. 2 and FIG. 3, a view point divider 800 according to an exemplary embodiment of the present disclosure includes a plurality of view point division units, and the plurality of view point division units may connect a plurality of lenticular lens 810 arranged in one direction. Each lenticular lens 810 may be elongated in one direction, and adjacent pixel rows corresponding to each lenticular lens 810 may have a different color arrangement. That is, the primary color displayed by the first pixel of an adjacent pixel row corresponding to each lenticular lens 810 may be different. For this, the extending direction of each lenticular lens 810 may be inclined to form an acute angle with the y-axis direction of the column direction.

Referring to FIG. 4, the view point divider 800 according to an exemplary embodiment of the present disclosure includes a plurality of view point division units, and the plurality of view point division units may be a plurality of openings 820 of a parallax barrier. A parallax barrier may further include light blocking parts 830 as well as the openings 820. The openings 820 may be arranged in one line and may be inclined to form an acute angle with the y-axis direction of a column direction, similar to the extending direction of the lens. If the view point divider 800 includes a parallax barrier instead of a lenticular lens 810, it may be assumed that the extending direction of the lenticular lens in the drawing represents an arrangement direction of the openings 820 that correspond to one view point.

In FIG. 1 and FIG. 2, the view point divider 800 is positioned between the display panel 300 and a viewer, but embodiments of the present disclosure are not limited thereto.

The view point division unit driver 850 is connected to the view point divider 800 to generate a driving signal to drive the view point divider 800.

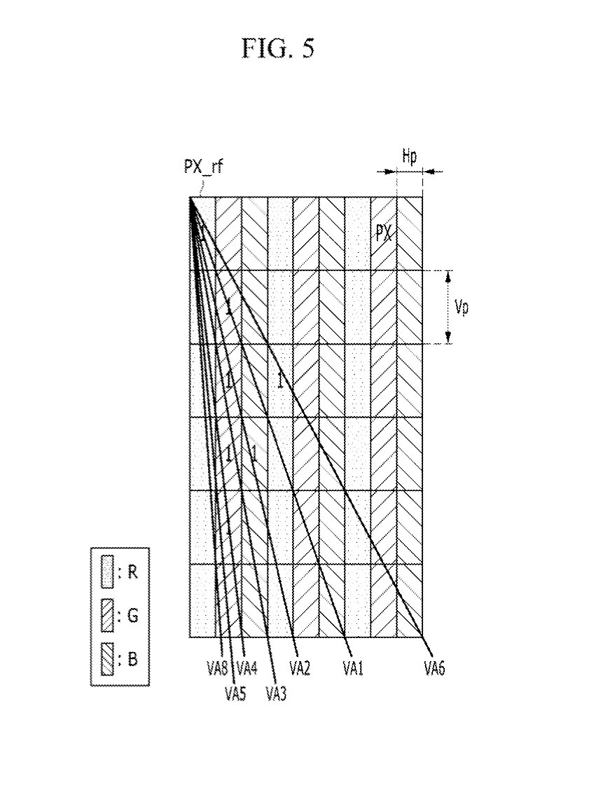

FIG. 5 shows an inclination angle of a view point divider for a display panel of a three-dimensional image display device according to an exemplary embodiment of the present disclosure,

The inclination angle with respect to the column direction (hereafter referred to as an inclination angle of the view point division unit) of the extending direction of the lenticular lens or the arrangement direction of the parallax barrier opening in the view point divider 800 of the three-dimensional image display device according to an exemplary embodiment of the present disclosure may vary.

The inclination angle of the view point division unit according to an exemplary embodiment of the present disclosure may be represented by Equation 1.

$$A = {tan}^{- 1} \frac{Hp \times a}{Vp \times b} \qquad [ Equation 1 ]$$

Here, Hp is a horizontal direction pitch of the pixels PX, and Vp is a vertical direction pitch of the pixels PX, a and b are respectively natural numbers, where b may be greater than 1.

By Equation 1, there exists a second pixel PX2 for the same view pointaligned the first pixel PX1 and observed through the same lenticular lens or parallax barrier opening that is offset a columns to the right and the b rows down from the first pixel PX1. For example, in FIG. 5, a pixel PX emitting light to the first view point (indicated by “1”) is represented as a reference pixel PX_rf, and various inclination angles of the view point division unit are shown by straight lines extending from the reference pixel PX_rf along the pixels PX that represent the first view point. Hereafter, the PX_rf represents the reference pixel for an inclination angle.

FIG. 5 shows possible inclination angles of the view point division unit, including a first inclination angle VA1, a second inclination angle VA2, a third inclination angle VA3, a fourth inclination angle VA4, a fifth inclination angle VA5, and a sixth inclination angle VA6. The first inclination angle VA1 corresponds to a=1 and b=1, the second inclination angle VA2 corresponds to a=2 and b=3, the third inclination angle VA3 corresponds to a=1 and b=2, the fourth inclination angle VA4 corresponds to a=1 and b=3, the fifth inclination angle VA5 corresponds to a=1 and b=4, the sixth inclination angle VA6 corresponds to a=3 and b=2, and the eighth inclination angle VA8 corresponds to a=1 and b=5. Here, a seventh inclination angle VA7 corresponding to a=3 and b=4 is possible, however for convenience of description, it is shown and described in the next exemplary embodiment.

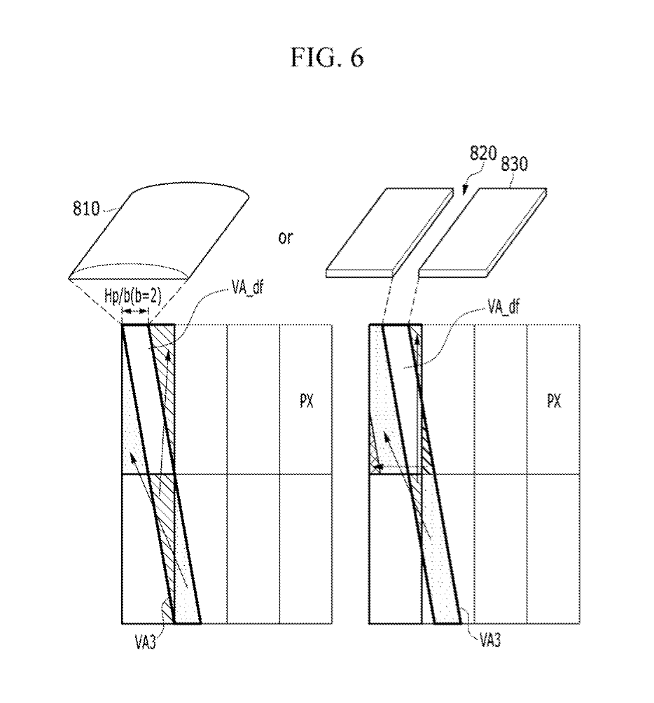

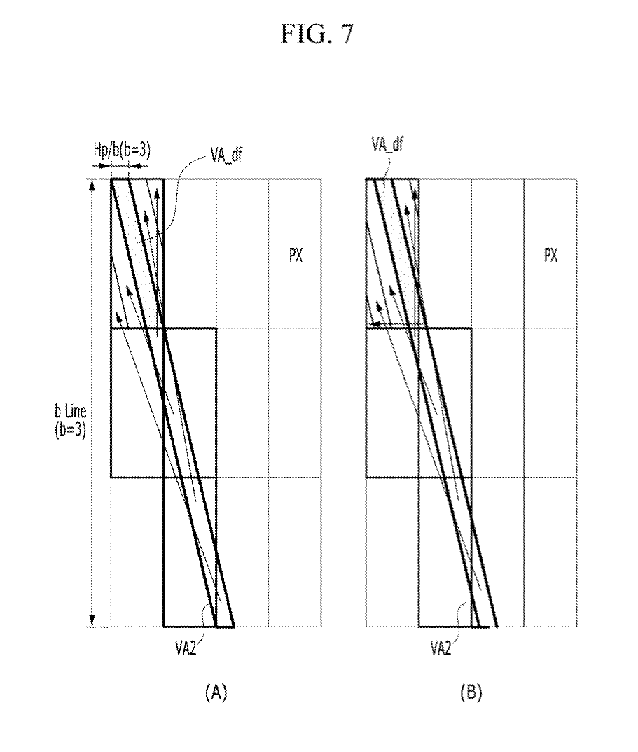

FIG. 6 shows a region of a display panel enlarged or transmitted by one lenticular lens or opening of a view point divider of a three-dimensional image display device according to an exemplary embodiment of the present disclosure, and FIG. 7 to FIG. 10 show a region of a display panel enlarged or transmitted by one lenticular lens or opening of a view point divider of a three-dimensional image display device according to an exemplary embodiment of the present disclosure when a view point divider is inclined with any one inclination angle.

Referring to FIG. 6, let a view point divider 800 according to an exemplary embodiment of the present disclosure include a lenticular lens 810, let Hp be a transverse pitch of the pixels PX, and consider a pixel PX viewed by the same lenticular lens 810 with respect to the pixels PX displaying the image of one view point. If this pixel PX is positioned under b rows, the lenticular lens 810 may be designed so that a region of the pixel PX having a width of m times (m is a natural number) Hp/b may be viewed at the optimal viewing distance OVD. Here, m may be 1. As described above, by controlling the focal distance of the lenticular lens 810 corresponding to the inclination angle of the view point division unit, the lenticular lens 810 may form a defocused region at the display panel 300.

Likewise, if the view point divider 800 according to an exemplary embodiment of the present disclosure includes a parallax barrier, the opening 820 of the parallax barrier may designed so that the transverse width of the region VA_df of the pixel PX viewed through the opening 820 of the parallax barrier arranged in one line may be m times Hp/b. This may be realized by optimizing the width of the opening 820 of the parallax barrier corresponding to the inclination angle of the view point division unit.

Accordingly, although the viewing position may be changed, the area of the region VA_df viewed by one lenticular lens 810 or one opening 820 is substantially the same as the area of one pixel PX such that no change of luminance at the viewer position is generated, and thereby no moiré pattern is generated, regardless of the opening shape of the pixel PX.

FIG. 6 illustrates the third inclination angle VA3 of the view point division unit. In this case, a=1 and b=2, and the transverse width of the region VA_df of the pixel PX viewed at the optimal viewing distance OVD through one lenticular lens 810 or one opening 820 may be Hp/2.

Referring to FIG. 6, the region of the pixel PX viewed at the corresponding view point through one lenticular lens 810 or one opening 820 and the region of the surrounding pixel PX are viewed together through the corresponding lenticular lens 810 or opening 820, and a sum of the areas thereof is substantially the same as the area of one pixel PX. Accordingly, regardless of the viewing position, the area of the region VA_df viewed through one lenticular lens 810 or one opening 820 is constant and no moiré pattern is generated.

FIG. 7 illustrates the second inclination angle VA2 of the view point division unit. In this case, a=2 and b=3 and the transverse width of the region VA_df of the pixel PX viewed at the optimal viewing distance OVD through one lenticular lens 810 or one opening 820 may be Hp/3. In this case, the region of the pixel PX viewed at the corresponding view point through one lenticular lens 810 or one opening 820 and the region of the surrounding pixel PX are viewed together through the corresponding lenticular lens 810 or opening, and a sum of the areas thereof is substantially the same as the area of one pixel PX. Accordingly, as shown in FIG. 7 (A) and FIG. 7 (B), although the viewing position has changed, the area of the region VA_df viewed through one lenticular lens 810 or one opening 820 is constant and no moiré pattern is generated.

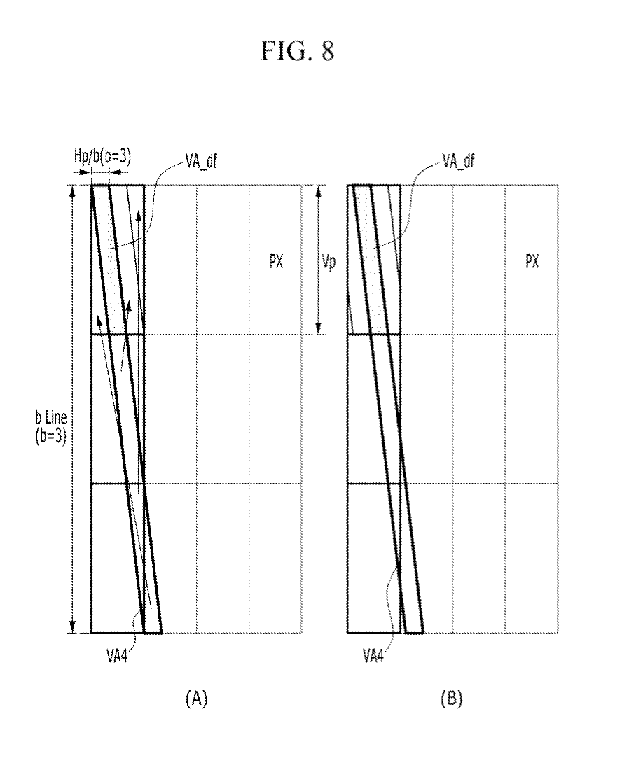

FIG. 8 illustrates the fourth inclination angle VA4 of the view point division unit. In this case, a=1 and b=3 and the transverse width of the region VA_df of the pixel PX viewed at the optimal viewing distance OVD through one lenticular lens 810 or one opening 820 may be Hp/3. In this case, the region of the pixel PX viewed at the corresponding view point through one lenticular lens 810 or one opening 820 and the region of the surrounding pixel PX are viewed together through the corresponding lenticular lens 810 or opening, and a sum of the areas thereof is substantially the same as the area of one pixel PX. Accordingly, as shown in FIG. 8 (A) and FIG. 8 (B), although the viewing position has changed, the area of the region VA_df viewed through one lenticular lens 810 or one opening 820 is constant and no moiré pattern is generated.

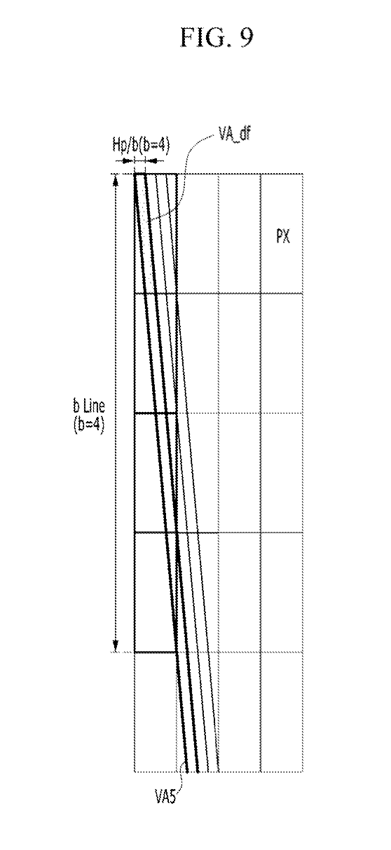

FIG. 9 illustrates the fifth inclination angle VA5 of the view point division unit. In this case, a=1 and b=4 and the transverse width of the region VA_df of the pixel PX viewed at the optimal viewing distance OVD through one lenticular lens 810 or one opening 820 may be Hp/4. In this case, the region of the pixel PX viewed at the corresponding view point through one lenticular lens 810 or one opening 820 and the region of the surrounding pixel PX are viewed together through the corresponding lenticular lens 810 or opening 820, and a sum of the areas thereof is substantially the same as the area of one pixel PX. Accordingly, although the viewing position has changed, the area of the region VA_df viewed through one lenticular lens 810 or one opening 820 is constant and no moiré pattern is generated.

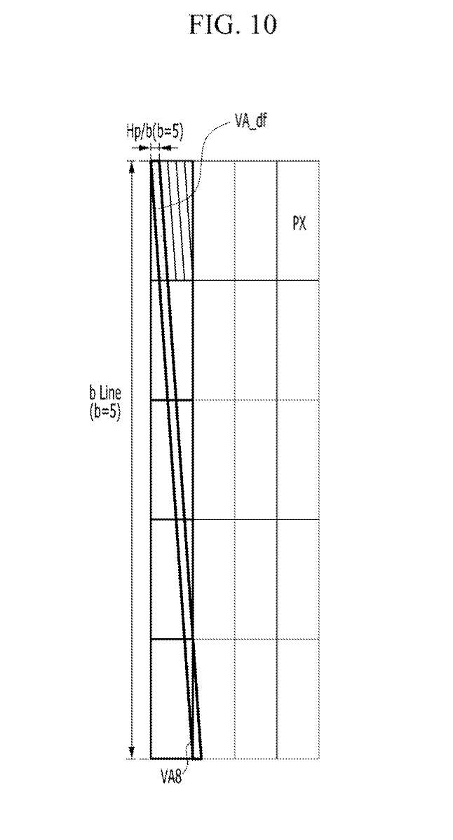

FIG. 10 illustrates the eighth inclination angle VA8 of the view point division unit. In this case, a=1 and b=5 and the transverse width of the region VA_df of the pixel PX viewed at the optimal viewing distance OVD through one lenticular lens 810 or one opening 820 may be Hp/5. In this case, the region of the pixel PX viewed at the corresponding view point through by one lenticular lens 810 or one opening 820 and the region of the surrounding pixel PX are viewed together through the corresponding lenticular lens 810 or opening 820, and a sum of the areas thereof is substantially the same as the area of one pixel PX. Accordingly, although the viewing position has changed, the area of the region VA_df viewed through one lenticular lens 810 or one opening 820 is constant and no moiré pattern is generated.

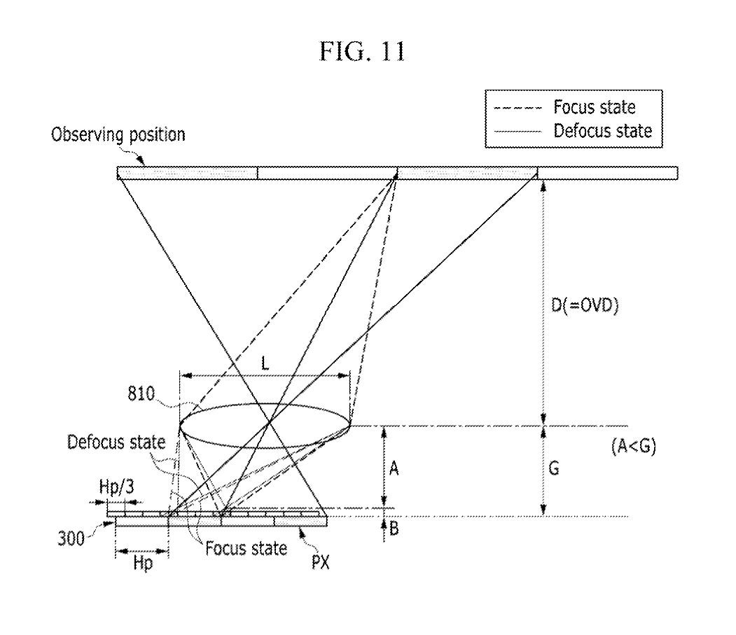

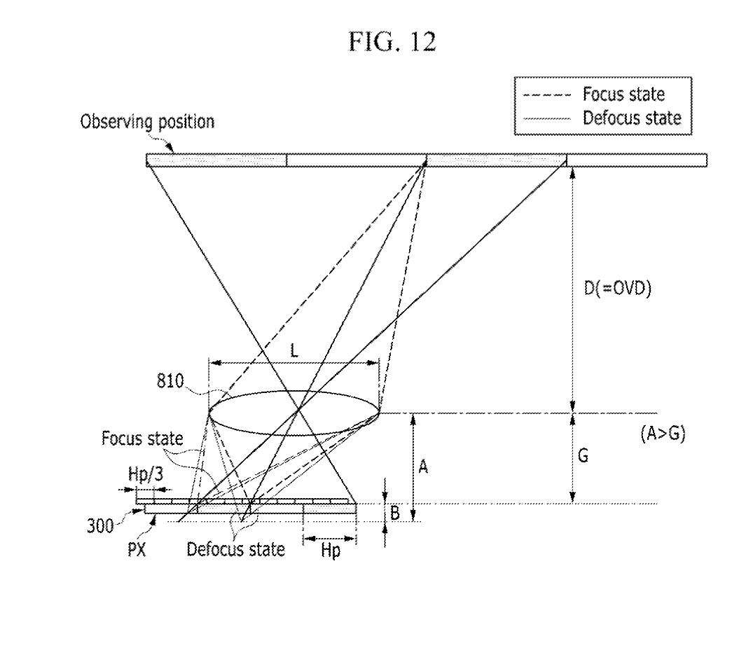

Next, a design condition of a lenticular lens such that no moiré pattern is generated will be described with reference to FIG. 11 and FIG. 12 as well as the above-described drawings.

FIG. 11 and FIG. 12 show a design condition of a view point divider when a lenticular lens is included in a view point divider of a three-dimensional image display device according to an exemplary embodiment of the present disclosure.

In an autostereoscopic three-dimensional image display device using the lenticular lens 810, let the optimal viewing distance OVD be represented by D, the focal distance of the lenticular lens 810 for the optimal viewing distance OVD of the three-dimensional image be F and a distance between the lenticular lens 810 and the display panel 300 be G. Then, the focal distance F of the lenticular lens 810 may satisfy Equation 2.

1/D+1/G≠1/F [Equation 2]

Accordingly, as described above, the pixel PX of the display panel 300 viewed through the lenticular lens 810 is not focused by the lenticular lens 810, but is defocused such that the transverse width of the viewed region VA_df of the pixel PX may be larger than 0.

If another pixel PX of the same view point viewed through the same lenticular lens 810 is positioned under the b row, the focal distance F of the lenticular lens 810 may be designed so that a region of the pixel PX having a transverse width of Hp/b may be viewed at the optimal viewing distance OVD. Here, Hp is the horizontal direction pitch of the pixels PX.

Referring to FIG. 11, when viewing at the optimal viewing distance OVD, and letting the distance A from the lenticular lens 810 where the lenticular lens 810 is focused be between the lenticular lens 810 and the display panel 300, i.e. A<G, and the pitch of the lenticular lens 810 be L, the focal distance Fs of the lenticular lens 810 may approximately satisfy the following Equation 3.

1/D+(b×L+Hp)/b×L×G=1/Fs [Equation 3]

Here, D is the optimal viewing distance OVD from the lenticular lens 810 to the position of a viewer.

Referring to FIG. 12, when viewing at the optimal viewing distance OVD, and letting the distance A from the lenticular lens 810 where the lenticular lens 810 is focused be outside the area between the lenticular lens 810 and the display panel 300, i.e. A>G, and the pitch of the lenticular lens 810 be L, the focal distance FL of the lenticular lens 810 may approximately satisfy the following Equation 4.

1/D+(b×L−Hp)/b×L×G=1/FL [Equation 4]

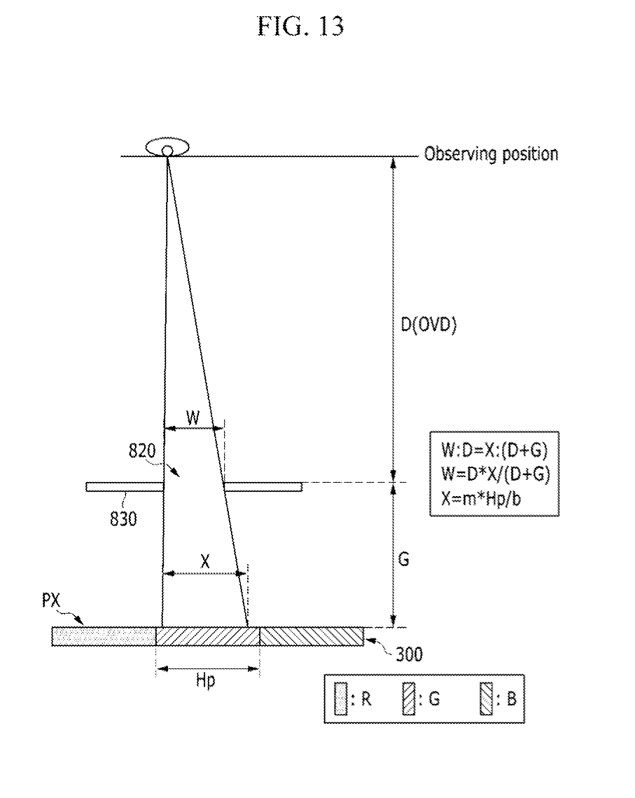

Next, a design condition of a parallax barrier opening such that no moiré pattern is generated will be described with reference to FIG. 13 to FIG. 15 as well as the above-described drawings.

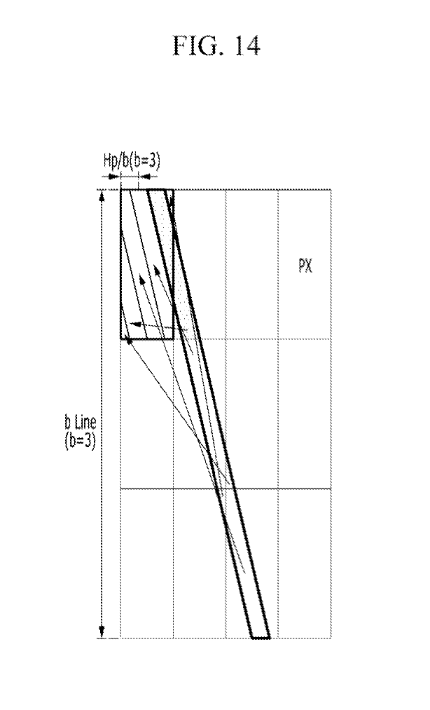

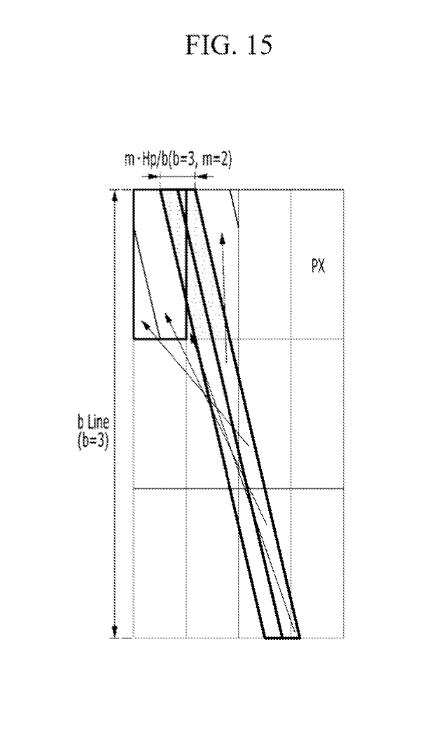

FIG. 13 shows a design condition of a view point divider when a parallax barrier is included in the view point divider of a three-dimensional image display device according to an exemplary embodiment of the present disclosure, and FIG. 14 and FIG. 15 show a region of a display panel transmitted through an opening of a parallax barrier when a parallax barrier is included in the view point divider of a three-dimensional image display device according to an exemplary embodiment of the present disclosure.

In an autostereoscopic three-dimensional image display device that uses a parallax barrier, consider another pixel PX for the same view point arranged in the same column as the pixel PX displaying the image of any view point when viewed through the opening 820. If that pixel PX is offset downward by b rows, a width W of the parallax barrier opening 820 may be designed so that a region of the pixel PX having a width of Hp/b or m×Hp/b (m is the natural number) may be viewed at the optimal viewing distance OVD.

Referring to FIG. 13, letting the optimal viewing distance OVD be indicated by D and the distance between the parallax barrier and the display panel 300 be G, the width W of the opening 820 may approximately satisfy Equation 4.

W=D×X/(D+G), where X=m×Hp/b. [Equation 4]

Here, m is a natural number, and X is the width of the region of the pixel PX viewed at the optimal viewing distance OVD through the opening 820.

The width of the region viewed at the optimal viewing distance OVD through the parallax barrier opening 820 may be Hp/b, as shown in FIG. 14, or m times Hp/b, as shown in FIG. 15 to improve luminance. FIG. 15 is an example in which m is 2.

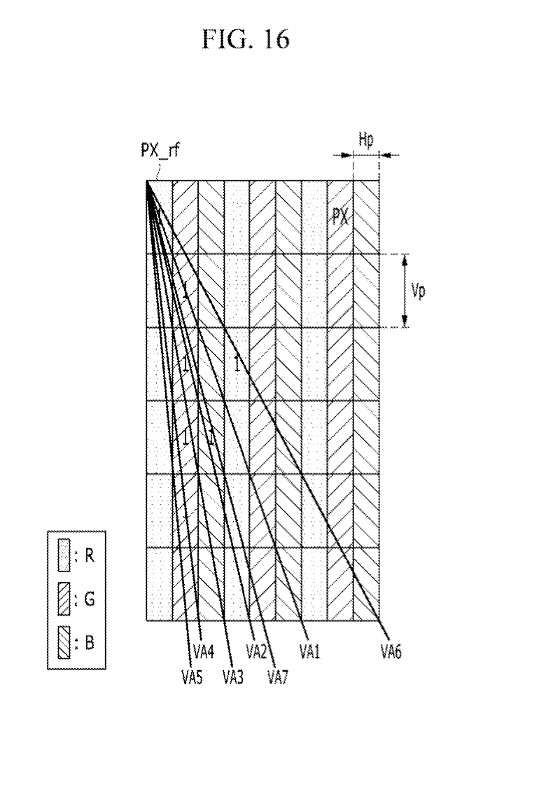

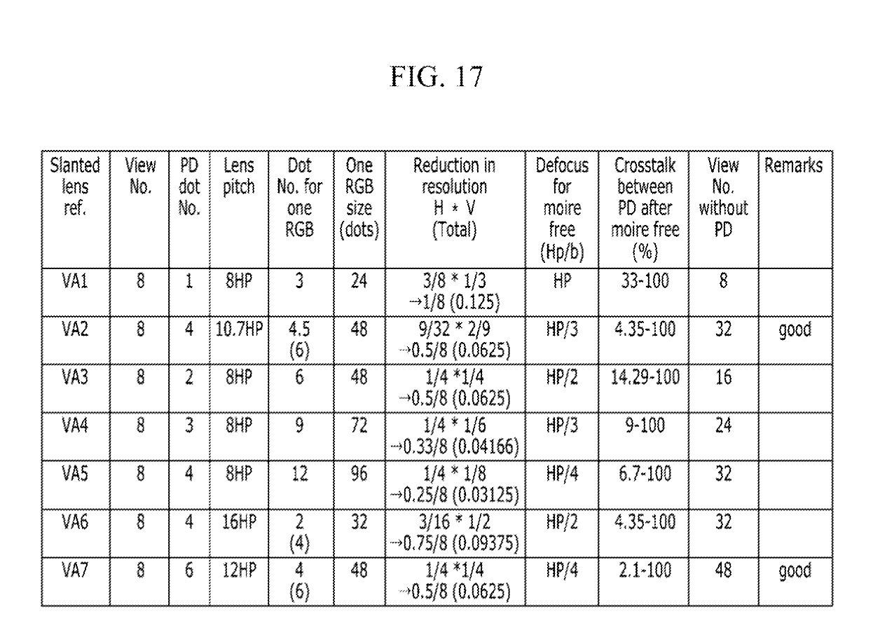

Next, a three-dimensional image display device according to an exemplary embodiment of the present disclosure will be described with reference to FIG. 16 and FIG. 17.

FIG. 16 shows a plurality of inclination angles of a view point divider for a display panel of a three-dimensional image display device according to an exemplary embodiment of the present disclosure, and FIG. 17 is a table of several display qualities as a function of inclination angles of a view point divider of a three-dimensional image display device according to an exemplary embodiment of the present disclosure.

Referring to FIG. 16, in a three-dimensional image display device according to a present exemplary embodiment, the inclination angle with respect to the column direction of the lenticular lens extending direction or the parallax barrier opening arrangement direction may vary, that is, like the inclination angle of the view point division unit of the exemplary embodiment of FIG. 5, and the inclination angle of the view point division unit may be represented by Equation 1 above. FIG. 16 shows most of the inclination angles shown in FIG. 5, however the seventh inclination angle VA7 with a=3 and b=4 is further shown instead of eighth inclination angle VA8.

The table of FIG. 17 sequentially summarizes a number of pixels PX forming the proximity pixel (PD) (defined below) for each of the first to seventh inclination angles VA1-VA7 for the same number of view points (e.g., 8 view points), a pitch (a condition of a view point divider) of the lenticular lens or parallax barrier opening, a number of pixels forming one R, G, B dot, a size of one dot viewed by a viewer, a resolution, the width of the lenticular lens or parallax barrier opening to prevent a moiré pattern, a crosstalk between proximity pixel sets PD under a moiré pattern removal condition, a number of view points without considering the proximity pixel set PD, and a final effect.

The basis of the data represented by the table of FIG. 17 will be described with reference to following drawings.

Referring to FIG. 17, a condition of a view point divider 800 having good display characteristics based on various factors will described. That is, for an autostereoscopic three-dimensional image display device, letting the horizontal direction pitch of the pixels PX be Hp and the vertical direction pitch be Vp, the display panel 300 may display a high quality three-dimensional image when the inclination angle of the view point division unit satisfies Equation 5 below. Here, a and b are natural numbers.

$$A = {tan}^{- 1} \frac{Hp \times a}{Vp \times b} , \\ 1 < a < b \qquad [ Equation 5 ]$$

Here, for the second inclination angle VA2, a=2 and b=3, and for the seventh inclination angle VA7, a=3 and b=4.

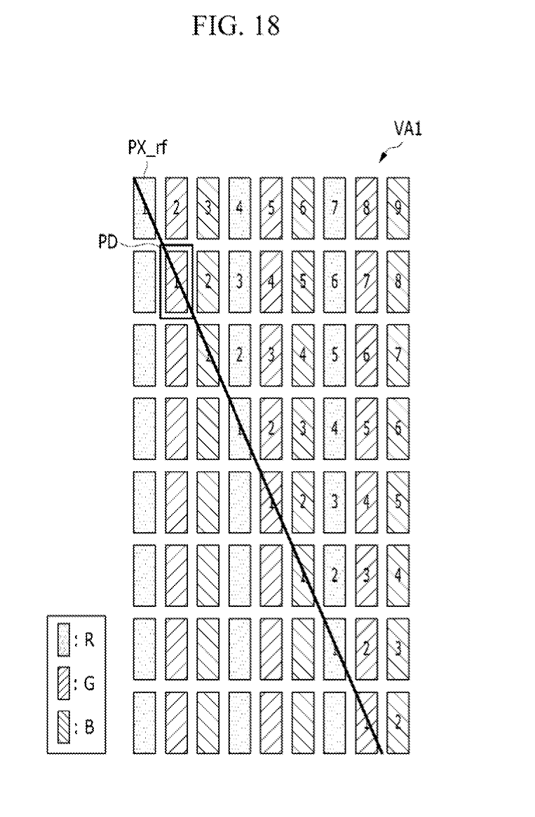

Next, a proximity pixel set PD as a function of the inclination angle of the view point division units of the three-dimensional image display device according to an exemplary embodiment of the present disclosure will be described with reference to FIG. 18 to FIG. 23 as well as FIG. 16 and FIG. 17.

FIG. 18 to FIG. 23 show a proximity pixel that represents corresponding crosstalk for several inclination angles of a view point division unit of a three-dimensional image display device according to an exemplary embodiment of the present disclosure.

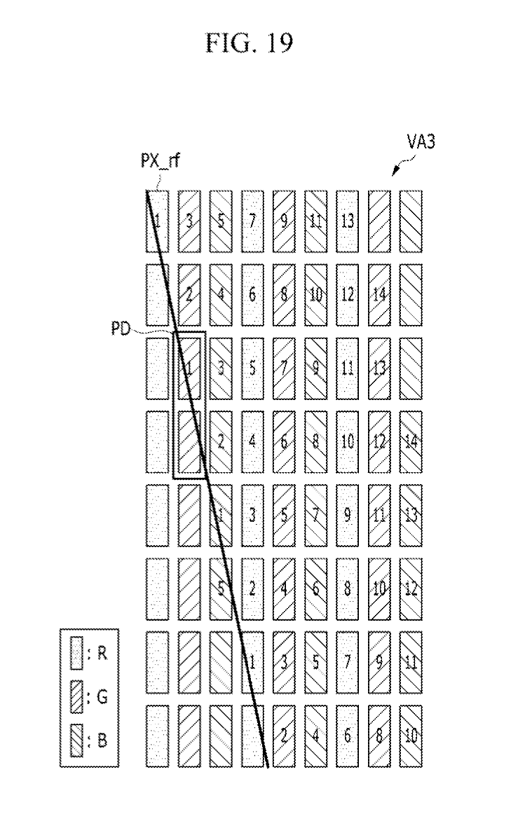

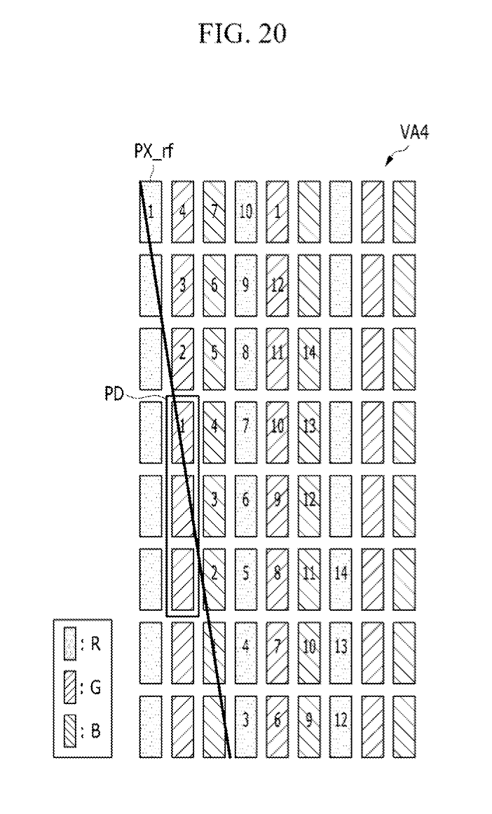

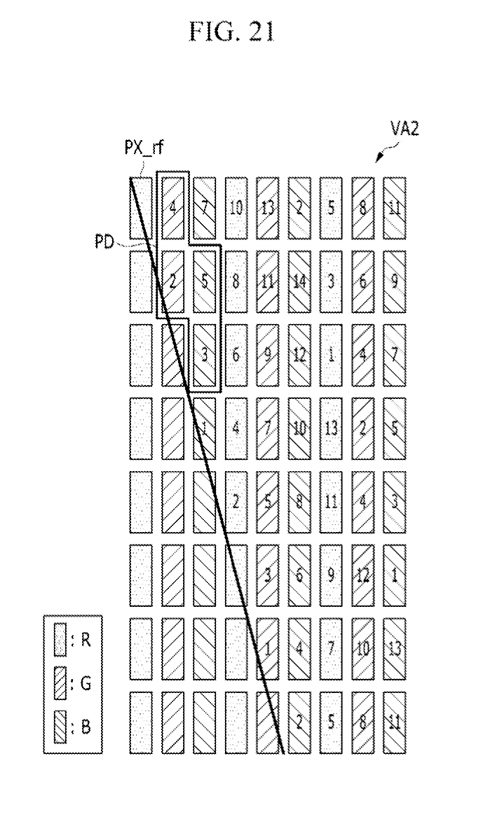

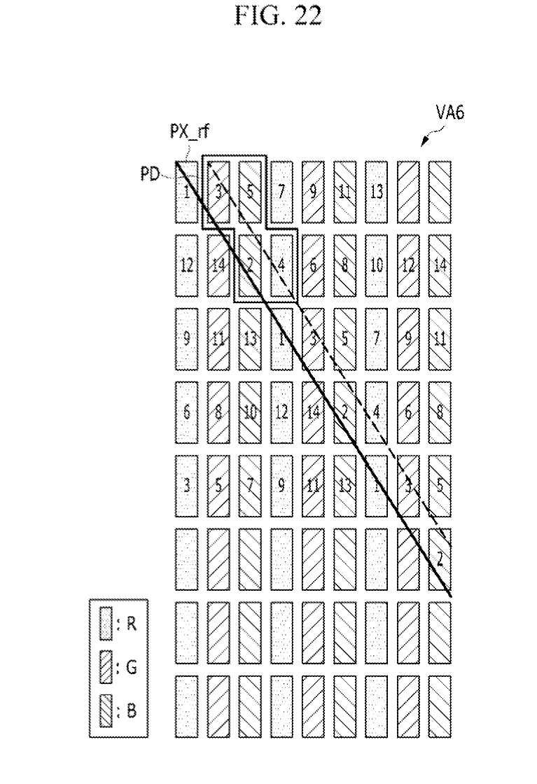

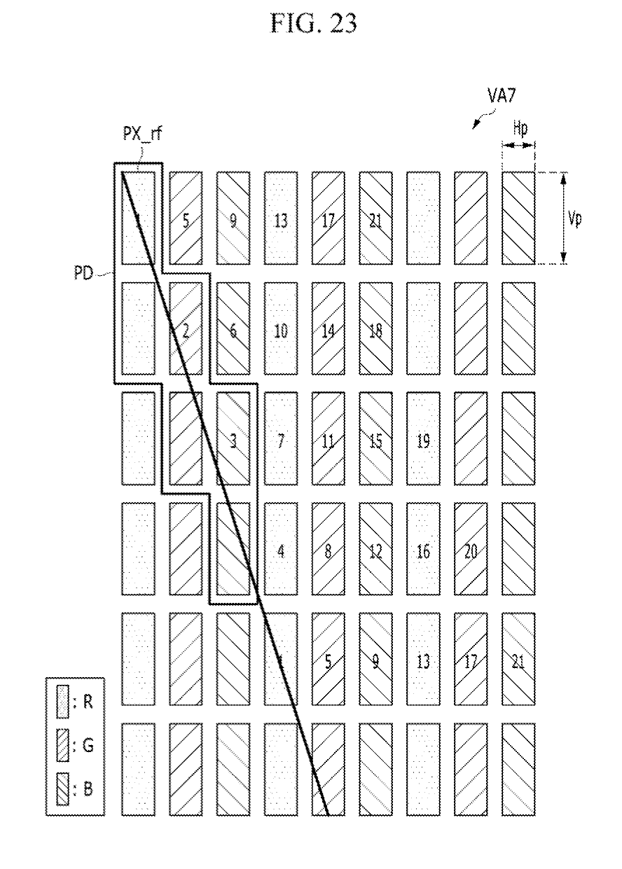

In detail, FIG. 18 shows the proximity pixel set PD for the first inclination angle VA1, FIG. 19 shows the proximity pixel set PD for the third inclination angle VA3, FIG. 20 shows the proximity pixel set PD for the fourth inclination angle VA4, FIG. 21 shows the proximity pixel set PD for the second inclination angle VA2, FIG. 22 shows the proximity pixel set PD for the sixth inclination angle VA6, and FIG. 23 shows the proximity pixel set PD for the seventh inclination angle VA7.

The proximity pixel set PD is a set that includes the first pixel PX1 and the pixels positioned between the first pixel PX1 and a second pixel PX2, viewed through the same lenticular lens or parallax barrier opening in one line, when there is a second pixel PX2 for the same view point with respect to the first pixel PX1 that represents the image at any one view point, when viewed through the same lenticular lens or parallax barrier opening in one line The pixels of the proximity pixel set PD may display the image at different view points or may display the image at the same view point.

Referring to FIG. 18, when the inclination angle of the lenticular lens or parallax barrier opening is the first inclination angle VA1, a=1 and b=1, and the number of pixels PX forming the proximity pixel set PD is 1. A shape of each proximity pixel set PD is the same as that of one pixel PX.

Referring to FIG. 19, when the inclination angle of the view point division unit is the third inclination angle VA3, a=1 and b=2, and the number of pixels PX forming the proximity pixel set PD is 2. The shape of each proximity pixel set PD is the same as that of two pixels PX adjacent in the column direction.

Referring to FIG. 20, when the inclination angle of the view point division unit is the fourth inclination angle VA4, a=1 and b=3, and the number of pixels PX forming the proximity pixel set PD is 3. The shape of each proximity pixel set PD is the same as that of three pixels PX adjacent in the column direction.

Referring to FIG. 21, when the inclination angle of the view point division unit is the second inclination angle VA2, a=2 and b=3, and the number of pixels PX forming the proximity pixel set PD is 4. The shape of each proximity pixel set PD includes two adjacent columns of two pixels each, with one column offset toward the second pixel PX2 by one pixel in the column direction.

Referring to FIG. 22, when the inclination angle of the view point division unit is the sixth inclination angle VA6, a=3 and b=2, and the number of pixels PX forming the proximity pixel set PD is 4. The shape of each proximity pixel set PD includes two adjacent rows of two pixels each, with one row offset toward the second pixel PX2 by one pixel in the row direction.

Referring to FIG. 23, when the inclination angle of the view point division unit is the seventh inclination angle VA7, a=3 and b=4, and the number of pixels PX forming the proximity pixel set PD is 6. The shape of each proximity pixel set PD includes three adjacent columns of two pixels each, with each successive column offset toward the second pixel PX2 by one pixel in the column direction.

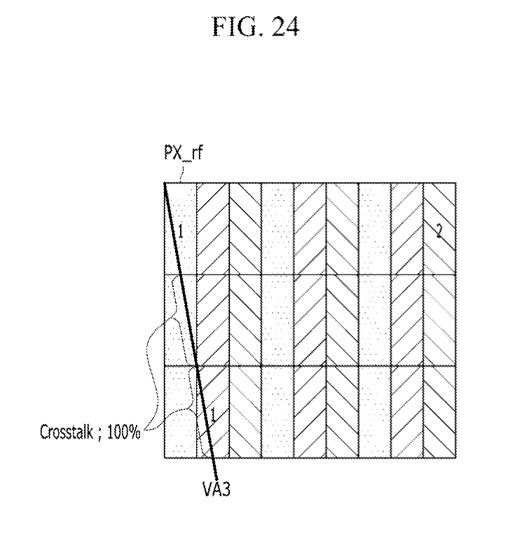

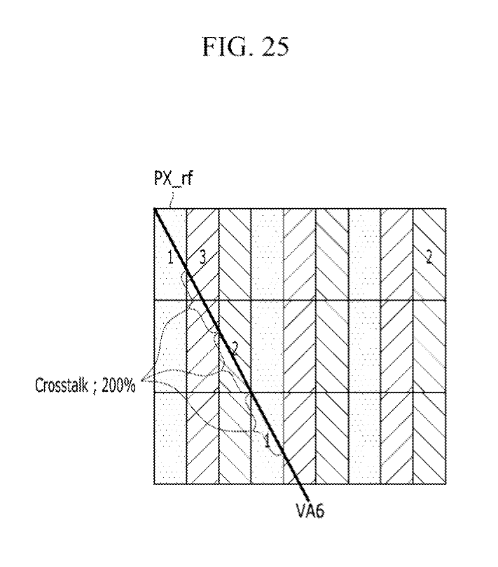

Next, crosstalk as a function of the inclination angle of the various view point division unit of a three-dimensional image display device according to an exemplary embodiment of the present disclosure will be described with reference to FIG. 24 and FIG. 25 as well as FIG. 16 and FIG. 17.

FIG. 24 and FIG. 25 show a method of calculating crosstalk for an inclination angle of a three-dimensional image display device according to an exemplary embodiment of the present disclosure.

Referring to FIG. 24, for example, if the inclination angle of the view point division unit is the third inclination angle VA3 and the reference pixel PX_rf represents the first view point, the pixel PX next to the view point is offset by two-lower rows and the one-right column. Crosstalk is generated when the image of another view point is viewed when viewing the image of the one view point, and a unit of crosstalk may correspond to a length of the pixel PX positioned between two adjacent pixels PX representing the same view point and viewed together.

Accordingly, in an example shown in FIG. 24, a ratio of the length of the pixel PX representing the first view point viewed by the same lenticular lens or parallax barrier opening and the length of the pixel PX representing the different view point is approximately 1:1, such that the crosstalk is approximately 100% with respect to the image of the first view point.

Referring to FIG. 25, for example, if the inclination angle of the view point division unit is the sixth inclination angle VA6 and the reference pixel PX_rf represents the first view point, the pixel PX next to the same view point is offset by two-lower rows and the three-right column. In an example shown in FIG. 25, the ratio of the length of the pixel PX representing the first view point viewed by the same lenticular lens or parallax barrier opening and the length of the pixel PX representing the different view point is approximately 1:2, such that crosstalk is approximately 200% with respect to the image of the first view point.

Accordingly, based on the example shown in FIG. 24 and FIG. 25, as the distance between two adjacent pixels PX decreases, the crosstalk decreases.

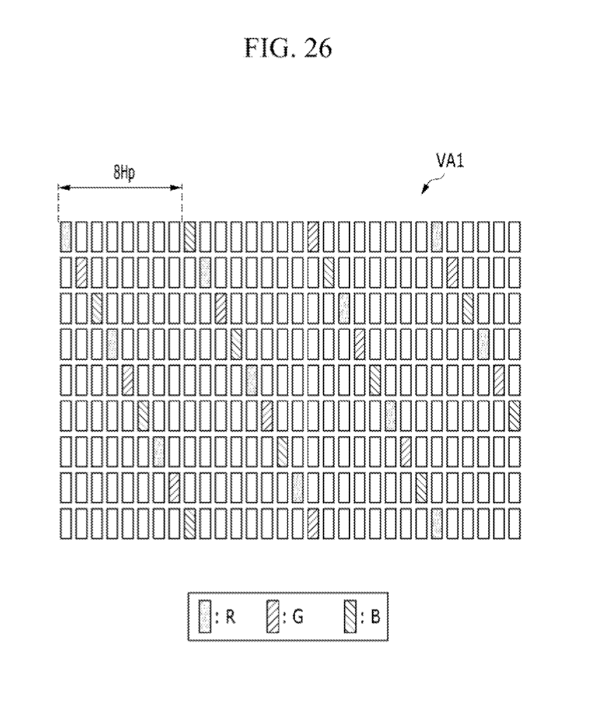

Next, referring to FIG. 26 to FIG. 46 as well as FIG. 16 and FIG. 17, the conditions shown in FIG. 17, that is, the conditions of the view point division unit as functions of the inclination angle of the various view point division units of a three-dimensional image display device according to an exemplary embodiment of the present disclosure, the number of pixels forming one dot, the size of one dot viewed by a viewer, the resolution, the width of the lenticular lens or parallax barrier opening to prevent the moiré pattern, the crosstalk between the proximity pixel set PD under the moiré pattern removal condition, and the number of view points without considering the proximity pixel set PD will be described.

In a present exemplary embodiment, a total number of view points in one unit view area for viewing the different images is 8 when one proximity pixel set PD displays the image of the same view point.

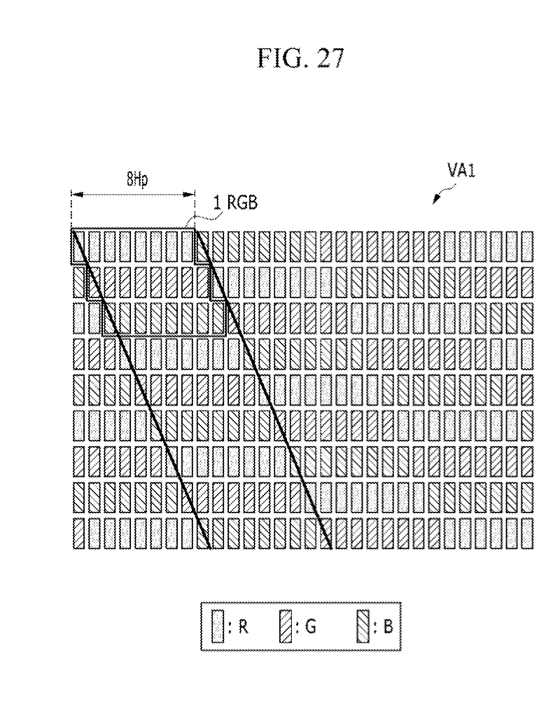

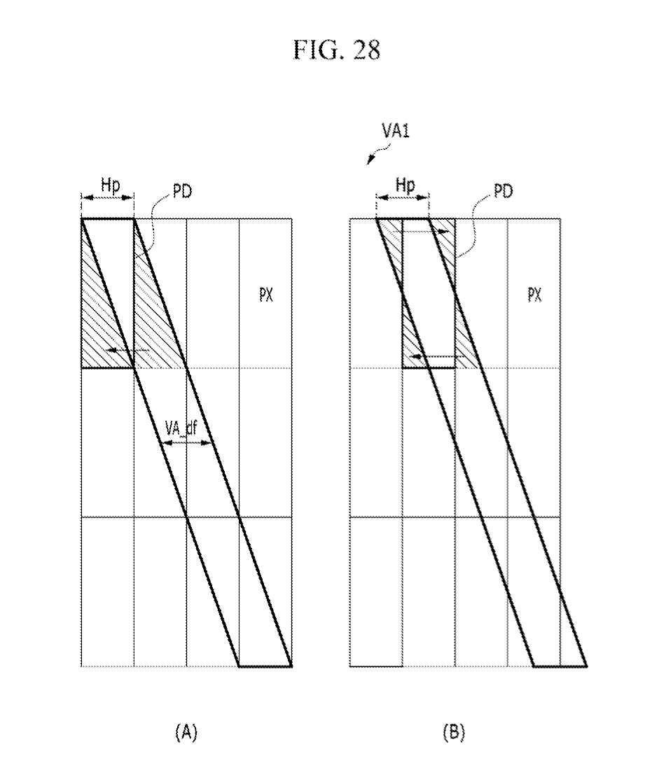

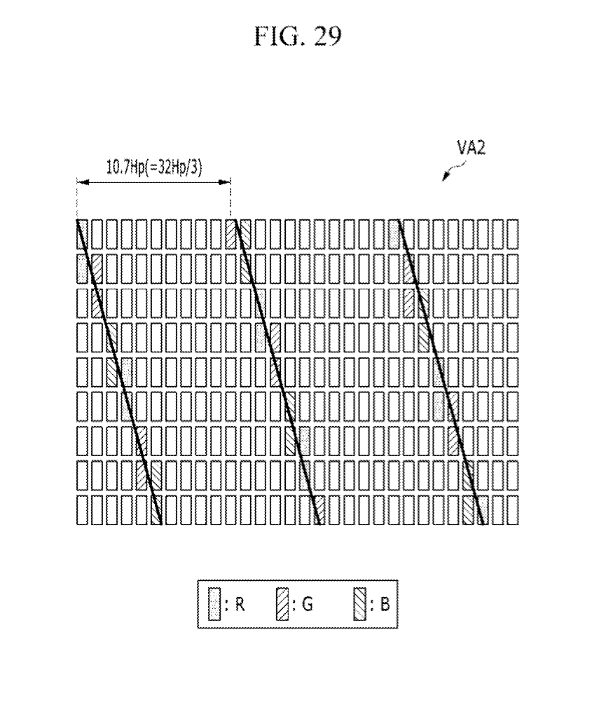

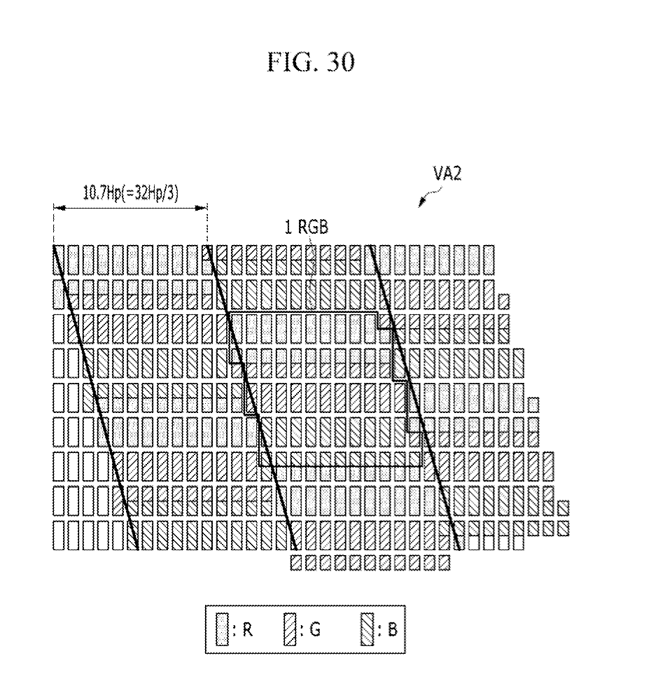

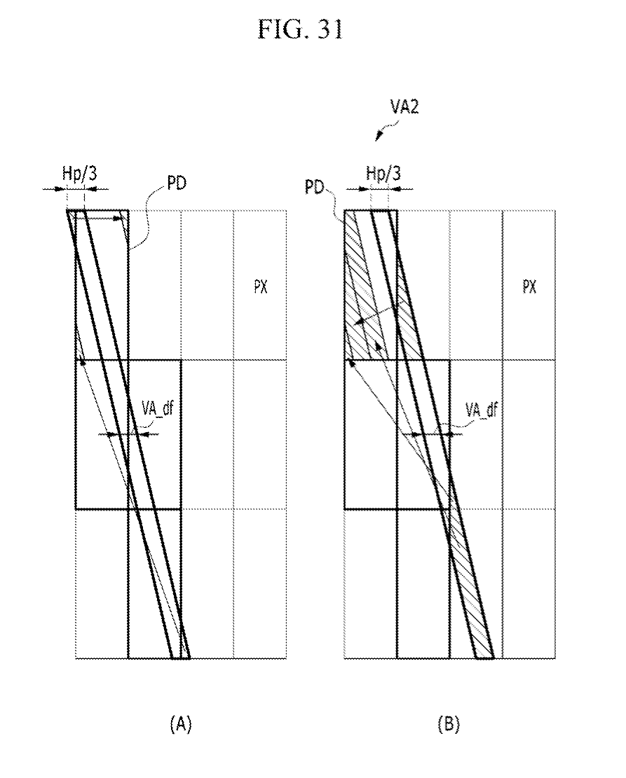

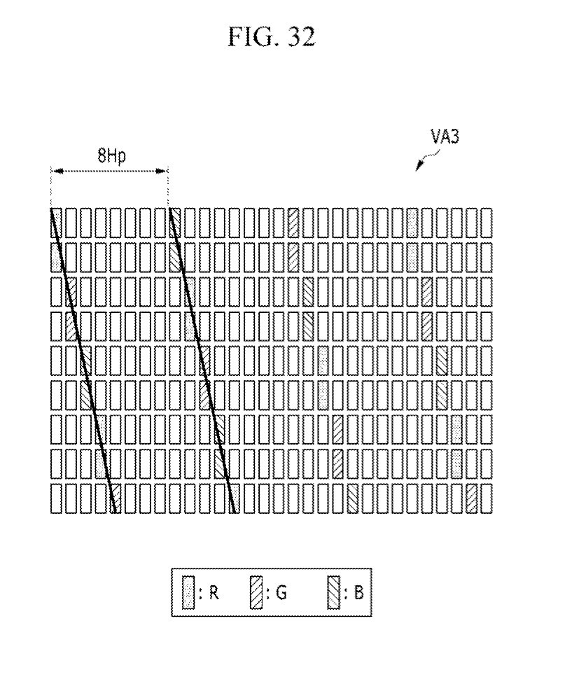

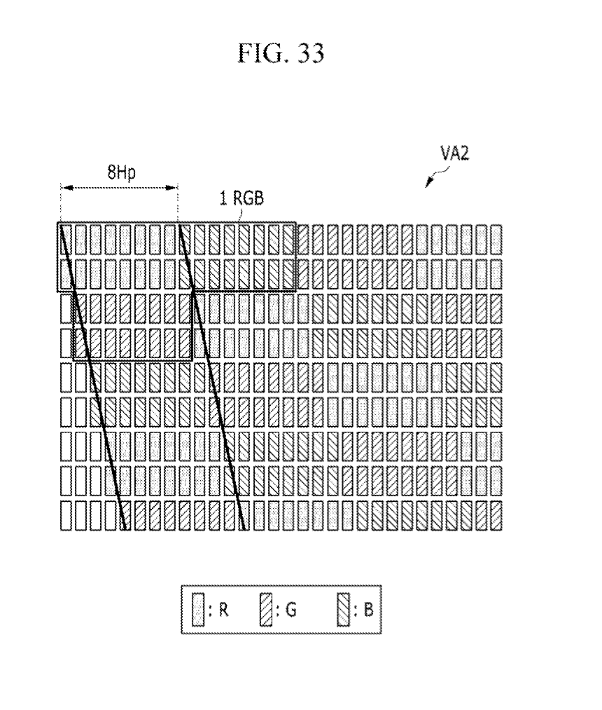

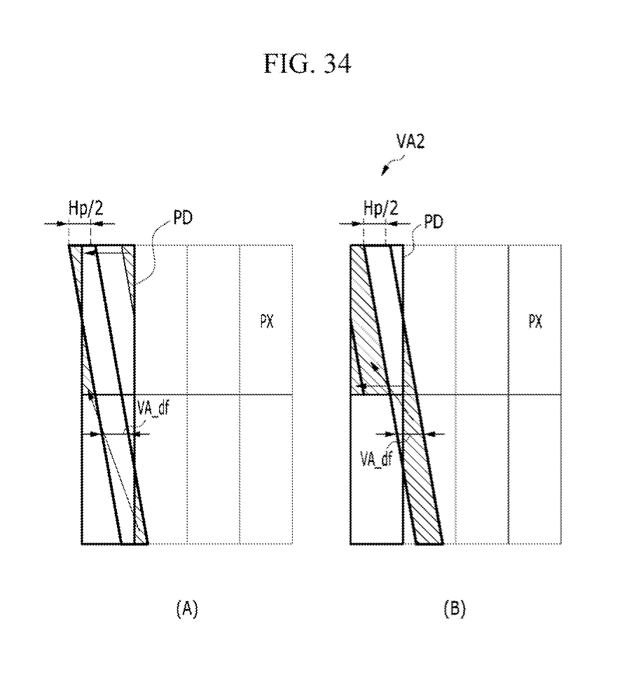

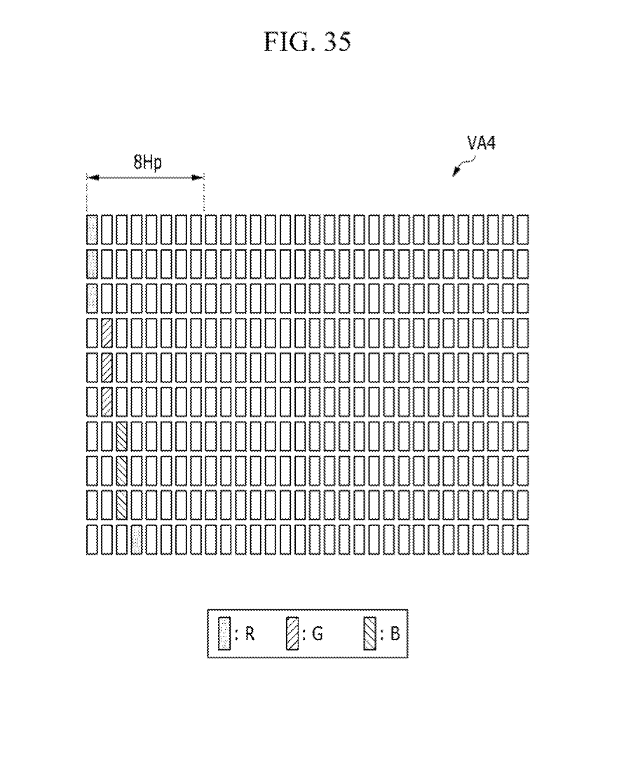

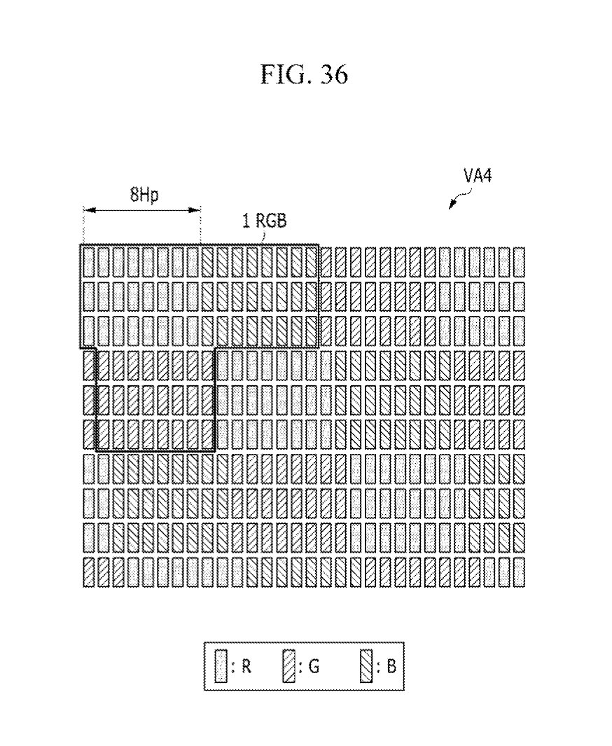

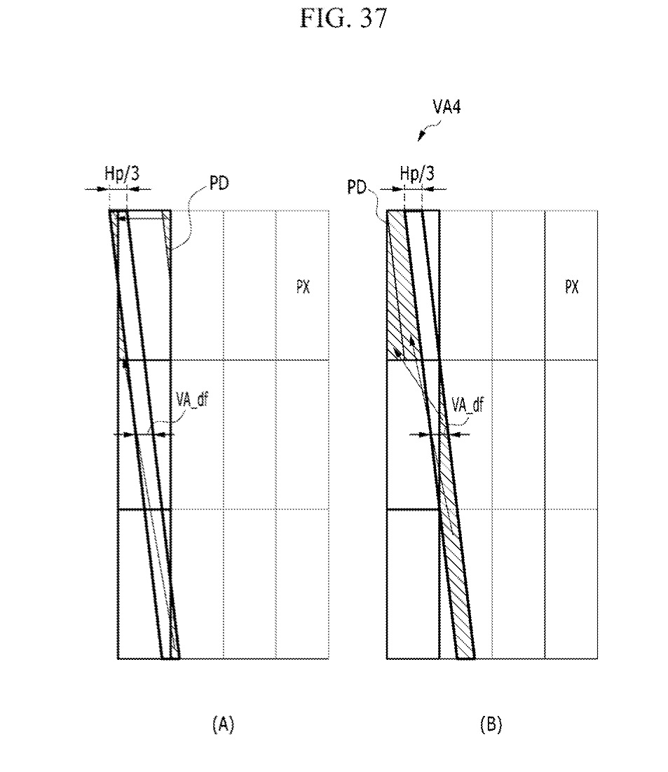

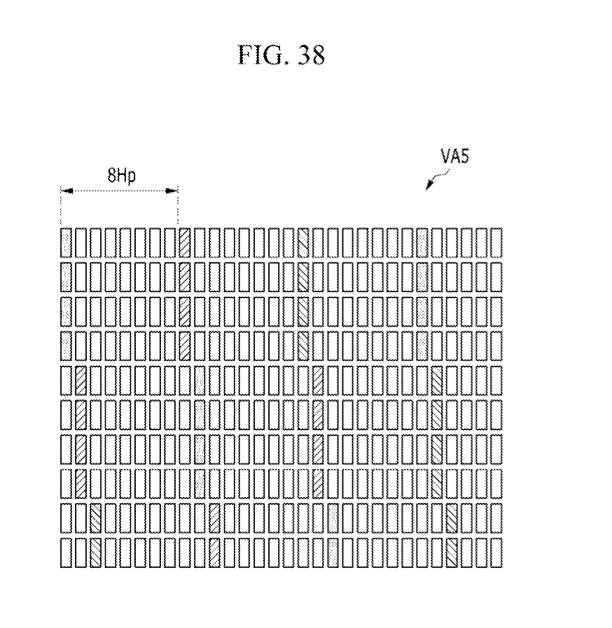

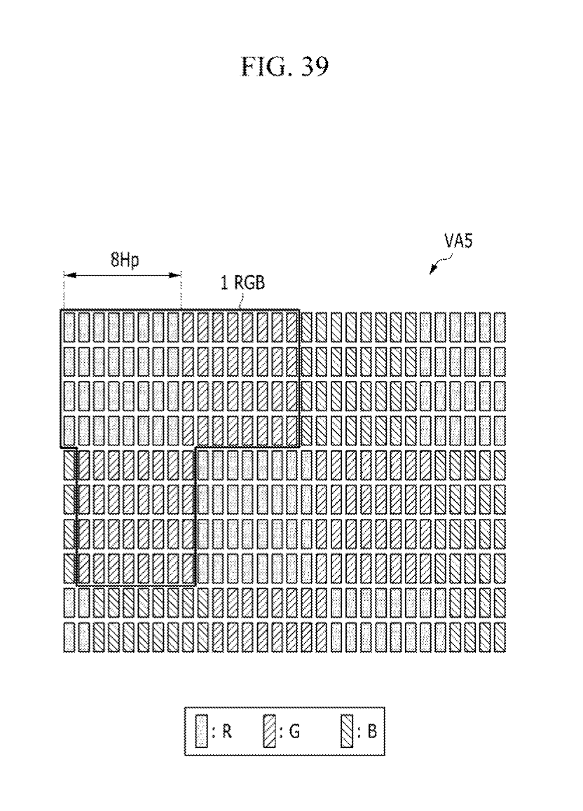

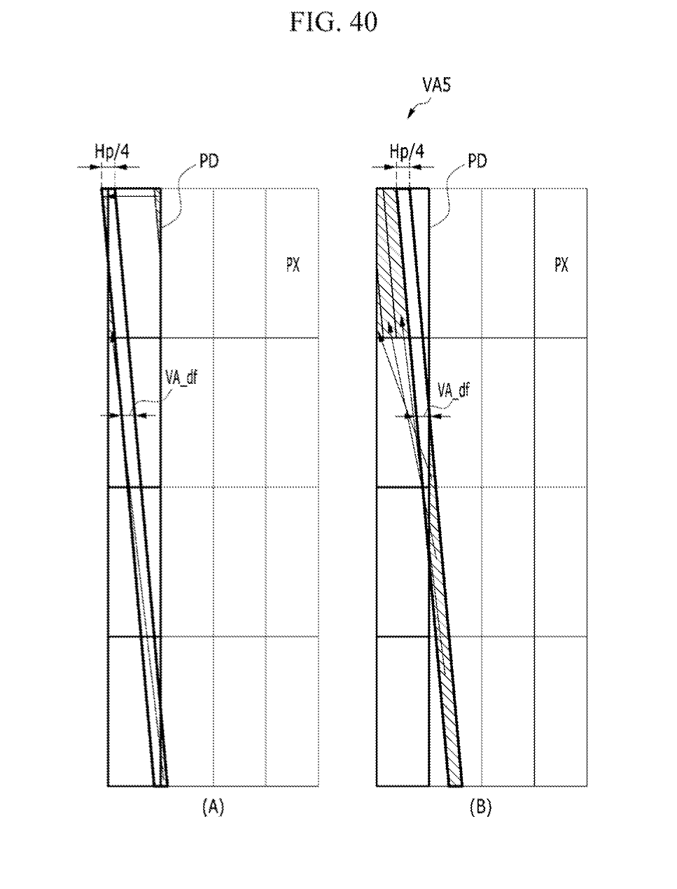

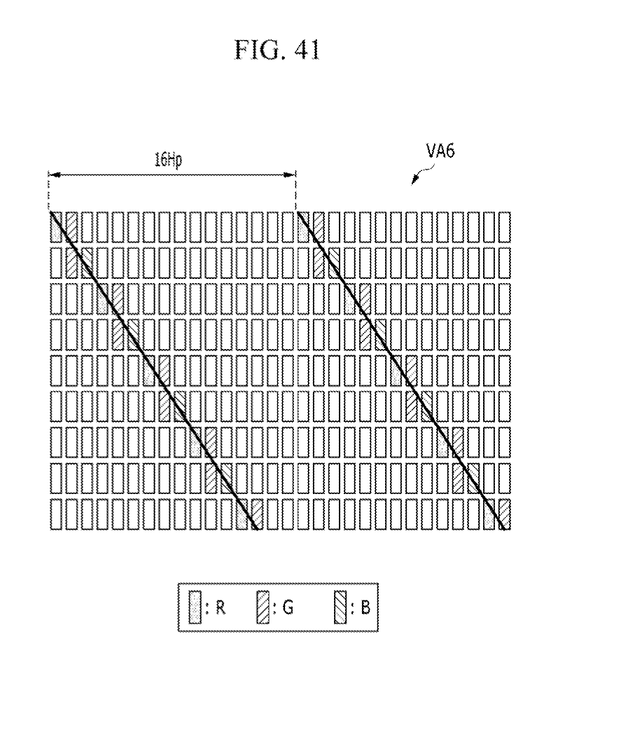

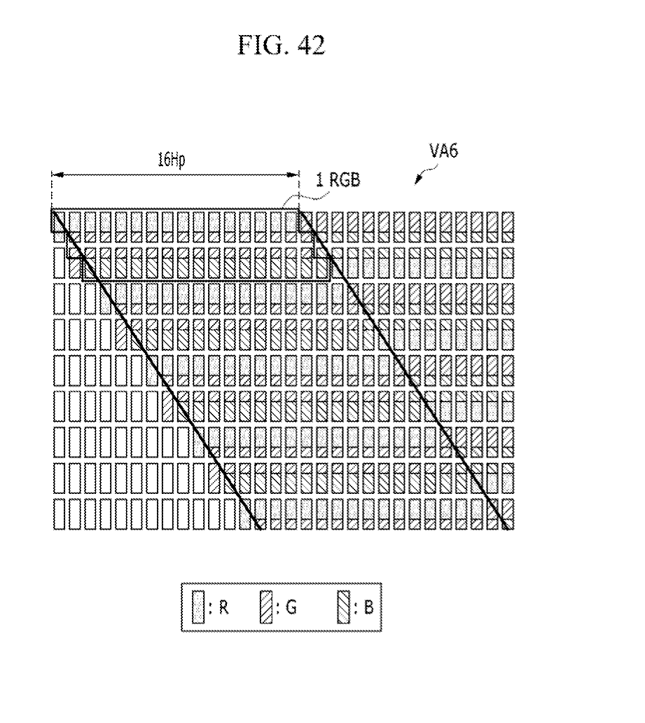

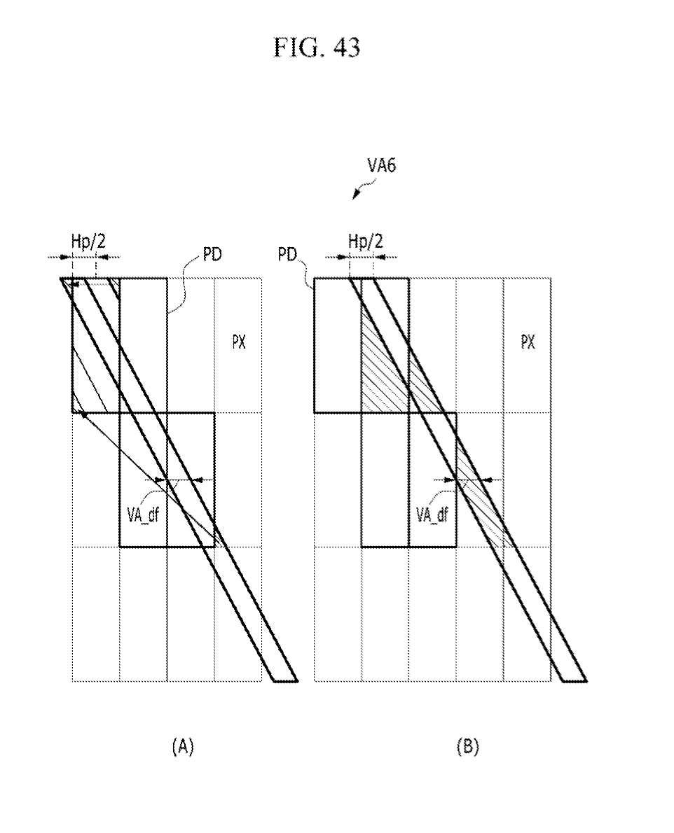

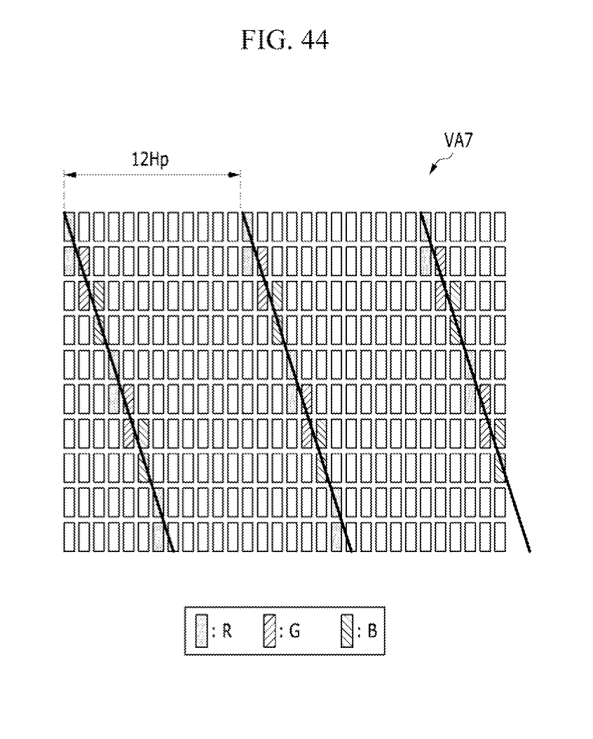

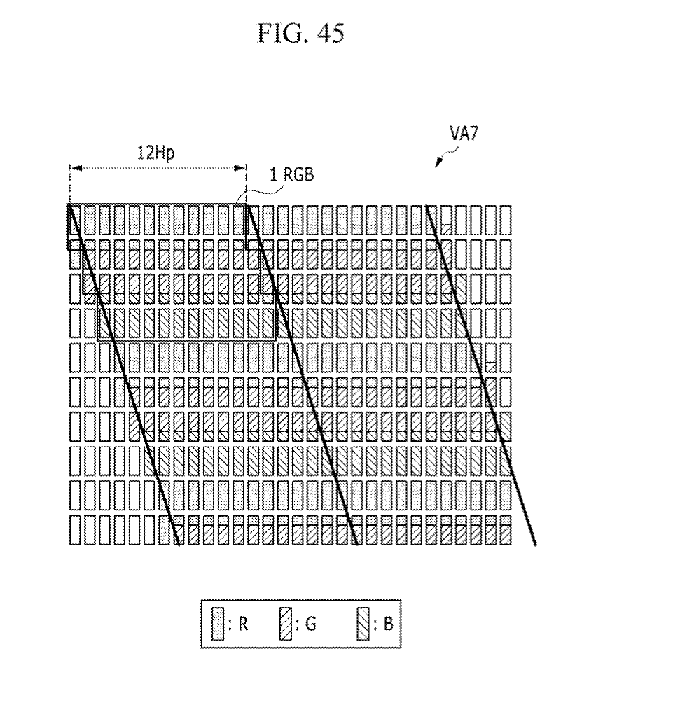

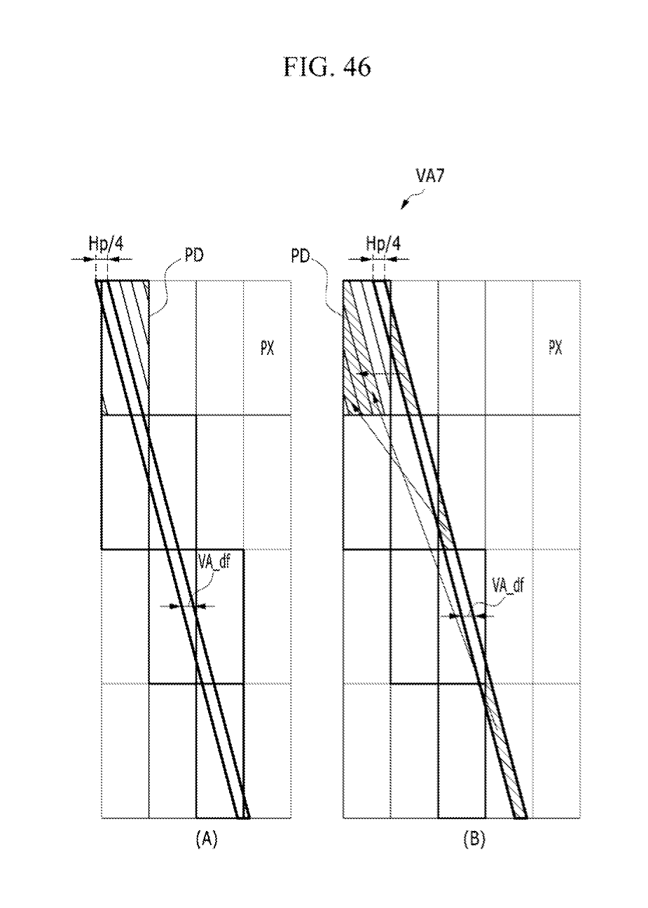

FIG. 26, FIG. 29, FIG. 32, FIG. 35, FIG. 38, FIG. 41, and FIG. 44 show the pixels that represent an image viewed at any one view point through the view point divider of the three-dimensional image display device according to an exemplary embodiment of the present disclosure, FIG. 27, FIG. 30, FIG. 33, FIG. 36, FIG. 39, FIG. 42, and FIG. 45 show the image actually viewed through the view point divider for the image displayed by the pixels shown in FIG. 26, FIG. 29, FIG. 32, FIG. 35, FIG. 38, FIG. 41, and FIG. 44, and FIG. 28, FIG. 31, FIG. 34, FIG. 37, FIG. 40, FIG. 43, and FIG. 46 show the region of the display panel enlarged or transmitted by the view point divider of the three-dimensional image display device shown in FIG. 26, FIG. 29, FIG. 32, FIG. 35, FIG. 38, FIG. 41, and FIG. 44.

Referring to FIG. 26, if the inclination angle of the view point division unit is the first inclination angle VA1, a=1 and b=1, and the pitch of the lenticular lens or parallax barrier opening is approximately 8Hp. Here, Hp is the horizontal direction pitch of the pixels PX, as described above. In addition, a number of pixels PX forming one R, G, B dot may be 3.

Referring to FIG. 27, the image viewed by a viewer is enlarged by the lenticular lens 810 or the parallax barrier opening 820. Accordingly, the size of one R, G, B dot of the image viewed by a viewer through one lenticular lens 810 or parallax barrier opening 820 corresponds to 3×8=24 pixels PX.

Accordingly, compared with the case of displaying a 2D image, the horizontal resolution is decreased to ⅜, and the vertical resolution is decreased to ⅓. As a result, the total resolution is reduced by about (⅜)×(⅓)=⅛≈0.125.

Referring to FIG. 28, as described above, to prevent a moiré pattern, the transverse width of the pixel PX region VA_df viewed at the optimal viewing distance OVD through the lenticular lens or parallax barrier opening may be Hp.

Under this moiré pattern removal condition, as shown in FIG. 28 (A), the image size at different view points of the pixel PX region VA_df viewed through one lenticular lens or one parallax barrier opening may be approximately the same as a maximum image size at the corresponding view point. Accordingly, a maximum value of the crosstalk between the proximity pixel set PD may be about 100%.

Under this moiré pattern removal condition, as shown in FIG. 28 (B), the image size at different view points of the pixel PX region VA_df viewed through one lenticular lens or one parallax barrier opening may be approximately 33% of the minimum image size of the corresponding view point. Accordingly, a minimum value of the crosstalk between the proximity pixel set PD may be about 33%.

When the pixels PX of the proximity pixel set PD display the image at a different view point, the number of view points capable of being displayed through a three-dimensional image display device according to an exemplary embodiment shown in FIG. 26 to FIG. 28 may be 8.

In a three-dimensional image display device according to an exemplary embodiment as shown in FIG. 26 to FIG. 28, and as shown in FIG. 17, the width of the pixel region viewed through the lenticular lens or the parallax barrier opening needed to prevent a moiré pattern is large enough such that a moiré pattern may be generated. Also, under the moiré pattern removal condition, the minimum value of the crosstalk is large.

Next, referring to FIG. 29, if the inclination angle of the view point division unit is the second inclination angle VA2, a=2 and b=3, and the pitch of the lenticular lens or parallax barrier opening may be about 32Hp/3=10.7Hp. In addition, the number of pixels PX forming one R, G, B dot is arithmetically 4.5, but substantially is 6.

Referring to FIG. 30, the image viewed by a viewer is enlarged by the lenticular lens 810 or the parallax barrier opening 820. Accordingly, the size of one R, G, B dot of the image viewed by a viewer through one lenticular lens 810 or parallax barrier opening 820 corresponds to 3×16=48 pixels PX.

Accordingly, compared with the case of displaying a 2D image, the horizontal resolution is decreased to 9/32, and the vertical resolution is decreased to 2/9. As a result, the total resolution is reduced by about ( 9/32)×( 2/9)=0.5/8≈0.0625.

Referring to FIG. 31, as described above, to prevent a moiré pattern, the transverse width of the pixel PX region VA_df viewed at the optimal viewing distance OVD through the lenticular lens or the parallax barrier opening may be Hp/3.

Under this moiré pattern removal condition, as shown in FIG. 31 (B), the image size at the different view points of the pixel PX region VA_df viewed through one lenticular lens or one parallax barrier opening may be approximately the same as the maximum image size of the corresponding view point. Accordingly, a maximum value of the crosstalk between the proximity pixel set PD may be about 100%.

Under this moiré pattern removal condition, as shown in FIG. 31 (A), the image size at the different view points of the pixel PX region VA_df viewed through one lenticular lens or one parallax barrier opening may be approximately 4.35% of the minimum image size of the corresponding view point. Accordingly, a minimum value of the crosstalk between the proximity pixel set PD may be about 4.35%.

When the pixels PX of the proximity pixel set PD display the image at the different view points, the number of view points displayed by a three-dimensional image display device according to an exemplary embodiment as shown in FIG. 29 to FIG. 31 may be 32.

In a three-dimensional image display device according to an exemplary embodiment as shown in FIG. 29 to FIG. 31, and as shown in FIG. 17, a number of pixels PX forming one R, G, B dot is small, the size of one R, G, B dot of the image viewed through one lenticular lens 810 or the parallax barrier opening 820 is small, the width of the pixel region viewed through the lenticular lens or the parallax barrier opening is sufficiently small such that no moiré pattern is easily generated, the minimum value of the crosstalk between the pixels of the proximity pixel set PD is small, and the number of view points to be displayed by the pixels PX of the proximity pixel set PD is large. Accordingly, for the second inclination angle VA2, a smooth 3D image may be displayed.

Next, referring to FIG. 32, if the inclination angle of the view point division unit is the third inclination angle VA3, a=1 and b=2, and the pitch of the lenticular lens or the parallax barrier opening may be about 8Hp. In addition, the number of pixels PX forming one R, G, B dot consisting of may be 6.

Referring to FIG. 33, the image viewed by a viewer is enlarged by the lenticular lens 810 or the parallax barrier opening 820. Accordingly, the size of one R, G, B dot viewed by a viewer through one lenticular lens 810 or parallax barrier opening 820 corresponds to 3×16=48 pixels PX.

Accordingly, compared to the case of displaying a 2D image, the horizontal resolution is decreased to ¼, and the vertical resolution is decreased to ¼. As a result, the total resolution is reduced to about (¼)×(¼)=0.5/8≈0.0625.

Referring to FIG. 34, as described above, to prevent a moiré pattern, the transverse width of the pixel PX region VA_df viewed at the optimal viewing distance OVD through the lenticular lens or the parallax barrier opening may be Hp/2.

Under this moiré pattern removal condition, as shown in FIG. 34 (B), the image size at the different view points of the pixel PX region VA_df viewed through one lenticular lens or one parallax barrier opening may be approximately the same as a maximum image size of the corresponding view point. Accordingly, a maximum value of the crosstalk between the proximity pixel set PD may be about 100%.

Under this moiré pattern removal condition, as shown in FIG. 34 (A), the image size at the different view points of the pixel PX region VA_df viewed through one lenticular lens or one parallax barrier opening may be approximately 14.29% of the minimum image size of the corresponding view point. Accordingly, a minimum value of the crosstalk between the proximity pixel set PD may be about 14.29%.

When the pixels PX of the proximity pixel set PD display the image at the different view points, the number of view points being displayed by a three-dimensional image display device according to an exemplary embodiment as shown in FIG. 32 to FIG. 34 may be 16.

In a three-dimensional image display device according to an exemplary embodiment as shown in FIG. 32 to FIG. 34, and as shown in FIG. 17, for the third inclination angle VA3, the size of one R, G, B dot of the image viewed through one lenticular lens 810 or parallax barrier opening 820 is small, and a resolution reduction with reference of a display of a 2D image is small.

Next, referring to FIG. 35, if the inclination angle of the view point division unit is the fourth inclination angle VA4, are a=1 and b=3, and the pitch of the lenticular lens or parallax barrier opening may be about 8Hp. In addition, the number of pixels PX forming one R, G, B dot may be 9.

Referring to FIG. 36, the image viewed by a viewer is enlarged by the lenticular lens 810 or the parallax barrier opening 820. Accordingly, the size of one R, G, B dot of the image viewed by a viewer through one lenticular lens 810 or parallax barrier opening 820 corresponds to 3×24=72 pixels PX.

Accordingly, compared with the case of displaying a 2D image, the horizontal resolution is decreased to ¼, and the vertical resolution is decreased to ⅙. As a result, the total resolution is reduced by about (¼)×(⅙)=0.33/8≈0.04166.

Referring to FIG. 37, as described above, to prevent a moiré pattern, a transverse width of the pixel PX region VA_df viewed at the optimal viewing distance OVD through the lenticular lens or the parallax barrier opening may be Hp/3.

Under this moiré pattern removal condition, as shown in FIG. 37 (B), the image size at different view points of the pixel PX region VA_df viewed through one lenticular lens or one parallax barrier opening may be approximately the same as the maximum image size of the corresponding view point. Accordingly, a maximum value of the crosstalk between the proximity pixel set PD may be about 100%.

Under this moiré pattern removal condition, as shown in FIG. 37 (A), the image size at the different view points of the pixel PX region VA_df viewed through one lenticular lens or one parallax barrier opening may be approximately 9% of the minimum image size at the corresponding view point. Accordingly, a minimum value of the crosstalk between the proximity pixel set PD may be about 9%.

When the pixels PX of the proximity pixel set PD display the image at the different view points, the number of view points being displayed through a three-dimensional image display device according to an exemplary embodiment as shown in FIG. 35 to FIG. 37 is 24.

In a three-dimensional image display device according to an exemplary embodiment as shown in FIG. 35 to FIG. 37, and as shown in FIG. 17, for the fourth inclination angle VA4, the resolution as compared the display of the 2D image is large.

Next, referring to FIG. 38, if the inclination angle of the view point division unit is the fifth inclination angle VA5, a=1 and b=4, and the pitch of the lenticular lens or parallax barrier opening of the may be about 8Hp. In addition, the number of pixels PX forming one R, G, B dot may be 12.

Referring to FIG. 39, the image viewed by a viewer is enlarged by the lenticular lens 810 or the parallax barrier opening 820. Accordingly, a size of one R, G, B dot of the image viewed by a viewer through one lenticular lens 810 or parallax barrier opening 820 corresponds to 3×32=96 pixels PX.

Accordingly, compared with the case of displaying a 2D image, the horizontal resolution is decreased to ¼, and the vertical resolution is decreased to ⅛. As a result, the total resolution is reduced by about (¼)×(⅛)=0.25/8≈0.03125.

Referring to FIG. 40, as described above, to prevent a moiré pattern, the transverse width of the pixel PX region VA_df viewed at the optimal viewing distance OVD through the lenticular lens or the parallax barrier opening may be Hp/4.

Under this moiré pattern removal condition, as shown in FIG. 40 (B), the image size at the different view points of the pixel PX region VA_df viewed through one lenticular lens or one parallax barrier opening may be approximately the same as a maximum image size of the corresponding view point. Accordingly, a maximum value of the crosstalk between the proximity pixel set PD may be about 100%.

Under this moiré pattern removal condition, as shown in FIG. 40 (A), the image size at the different view points of the pixel PX region VA_df viewed through one lenticular lens or one parallax barrier opening may be approximately 6.7% of the minimum image size of the corresponding view point. Accordingly, a minimum value of the crosstalk between the proximity pixel set PD may be about 6.7%.

When the pixels PX of the proximity pixel set PD display the image of the different view point, the number of view points being displayed through a three-dimensional image display device according to an exemplary embodiment as shown in FIG. 35 to FIG. 37 is 32.

In a three-dimensional image display device according to an exemplary embodiment as shown in FIG. 38 to FIG. 40, and as shown in FIG. 17, for the fifth inclination angle VA5, the resolution with reference to the display of a 2D image is large.

Next, referring to FIG. 41, if the inclination angle of the view point division unit is the sixth inclination angle VA6, a=3 and b=2, and the pitch of the lenticular lens or parallax barrier opening may be about 16Hp. In addition, the number of pixels PX forming one R, G, B dot is arithmetically 2, but is substantially 4.

Referring to FIG. 42, the image viewed by a viewer is enlarged by the lenticular lens 810 or parallax barrier opening 820. Accordingly, the size of one R, G, B dot consisting of the image viewed by a viewer through one lenticular lens 810 or parallax barrier opening 820 corresponds to 32 pixels PX.

Accordingly, compared with the case of displaying 2D image, the horizontal resolution is decreased to 3/16, and the vertical resolution is decreased to ½. As a result, the total resolution is reduced by about ( 3/16)×(½)=0.75/8≈0.09375.

Referring to FIG. 43, as described above, to prevent a moiré pattern, the transverse width of the pixel PX region VA_df viewed at the optimal viewing distance OVD through the lenticular lens or parallax barrier opening may be Hp/2.

Under this moiré pattern removal condition, as shown in FIG. 43 (B), the image size at the different view points of the pixel PX region VA_df viewed through one lenticular lens or one parallax barrier opening may be approximately the same as a maximum image size of the corresponding view point. Accordingly, a maximum value of the crosstalk between the proximity pixel set PD may be about 100%.

Under this moiré pattern removal condition, as shown in FIG. 43 (A), the image size at the different view points of the pixel PX region VA_df viewed through one lenticular lens or one parallax barrier opening may be approximately 4.35% of a minimum image size at the corresponding view point. Accordingly, a minimum value of the crosstalk between the proximity pixel set PD may be about 4.35%.

When the pixels PX of the proximity pixel set PD display the image at the different view points, the number of view points being displayed through a three-dimensional image display device according to an exemplary embodiment as shown in FIG. 35 to FIG. 37 is 32.

In a three-dimensional image display device according to an exemplary embodiment as shown in FIG. 41 to FIG. 43, and as shown in FIG. 17, for the sixth inclination angle VA6, the pitch of the lenticular lens or parallax barrier opening is very large, and the horizontal resolution is very large.

Next, referring to FIG. 44, if the inclination angle of the view point division unit is the second inclination angle VA7, a=3 and b=4, and the pitch of the lenticular lens or parallax barrier opening of the may be about 12Hp. In addition, the number of pixels PX forming one R, G, B dot is arithmetically 4, but substantially is 6.

Referring to FIG. 45, the image viewed by a viewer is enlarged by the lenticular lens 810 or parallax barrier opening 820. Accordingly, the size of one R, G, B dot of the image viewed by the viewer through one lenticular lens 810 or parallax barrier opening 820 corresponds to 48 pixels PX.

Accordingly, compared with the case of displaying a 2D image, the horizontal resolution is decreased to ¼, and the vertical resolution is decreased to ¼. As a result, the total resolution is by about (¼)×(¼)=0.5/8≈0.0625.

Referring to FIG. 46, as described above, to prevent a moiré pattern, the transverse width of the pixel PX region VA_df viewed at the optimal viewing distance OVD through the lenticular lens or parallax barrier opening may be Hp/4.

Under this moiré pattern removal condition, as shown in FIG. 46 (B), the image size at the different view points of the pixel PX region VA_df viewed through one lenticular lens or one parallax barrier opening may be approximately the same as a maximum image size at the corresponding view point. Accordingly, a maximum value of the crosstalk between the proximity pixel set PD may be about 100%.

Under this moiré pattern removal condition, as shown in FIG. 46 (A), the image size at the different view points of the pixel PX region VA_df viewed through one lenticular lens or one parallax barrier opening may be approximately 2.1% of a minimum imagesize at the corresponding view point. Accordingly, a minimum value of the crosstalk between the proximity pixel set PD may be about 2.1%.

When the pixels PX of the proximity pixel set PD display the image at the different view points, the number of view points being displayed through a three-dimensional image display device according to an exemplary embodiment shown in FIG. 44 to FIG. 46 may be 48.

In a three-dimensional image display device according to an exemplary embodiment as shown in FIG. 44 to FIG. 46, and as shown in FIG. 17, for the seventh inclination angle VA7, the number of pixels PX forming one R, G, B dot consisting is very small, the size of one R, G, B dot of the image viewed through one lenticular lens 810 or parallax barrier opening 820 is small, the width of the pixel region viewed through the lenticular lens or parallax barrier opening to prevent a moiré pattern is small, the minimum crosstalk value is small, and the number of viewpoints being displayed when the pixels PX of the proximity pixel set PD display the image at different viewpoints is large. In addition, the resolution reduction with reference to the 2D image display is small.

As described, as the result of estimating the display quality according to several inclination angles of the lenticular lens or parallax barrier opening, of the several examples shown in FIG. 16 and FIG. 17, for the second inclination angle VA2 and the seventh inclination angle VA7, display characteristics such as crosstalk and the number of view points are such that no moiré pattern is generated.

That is, as described above, in an autostereoscopic three-dimensional image display device, the display panel 300 can display a high quality three-dimensional image when the inclination angle of the view point division unit satisfies the above-described Equation 5.

At this time, to prevent the generation of a moiré pattern according to the change of a viewing position, in the case of the second inclination angle VA2, the width of the lenticular lens or parallax barrier opening may be designed so that the transverse width of the pixel PX region viewed at the optimal viewing distance OVD may be Hp/3. In the case of the seventh inclination angle VA7, the width of the lenticular lens or parallax barrier opening may be designed so that the transverse width of the pixel PX region viewed at the optimal viewing distance OVD may be Hp/4.

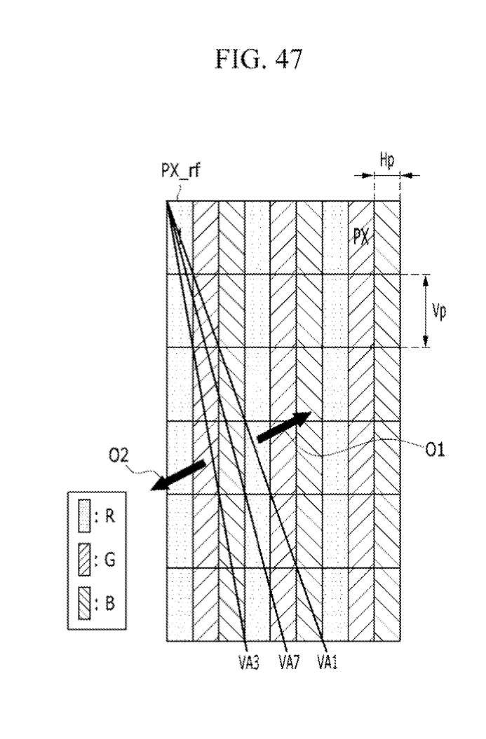

Next, referring to FIG. 47 to FIG. 52, several characteristics of a high quality display when the inclination angle of the view point division unit satisfies Equation 5 in a three-dimensional image display device according to an exemplary embodiment of the present disclosure will be described.

FIG. 47 shows several inclination angles of a view point division unit with respect to a display panel of a three-dimensional image display device according to an exemplary embodiment of the present disclosure.

FIG. 47 shows the first inclination angle VA1, the third inclination angle VA3, and the seventh inclination angle VA7. When the inclination angle of the view point division unit, indicated by an arrow O1, is larger than the first inclination angle VA1, there is binocular disparity of the three-dimensional image in the vertical direction, which can reduce a display quality of the 3D image.

In addition, as indicated by an arrow O2, when the inclination angle of the view point division unit is larger than the third inclination angle VA3, both crosstalk and the size of one R, G, B dot viewed by the viewer increases, which also reduces display quality.

Accordingly, selecting the second inclination angle VA2 and the seventh inclination angle VA7 to be positioned between the third inclination angle VA3 and the first inclination angle VA1 may improve display quality of the 3D image and reduce crosstalk.

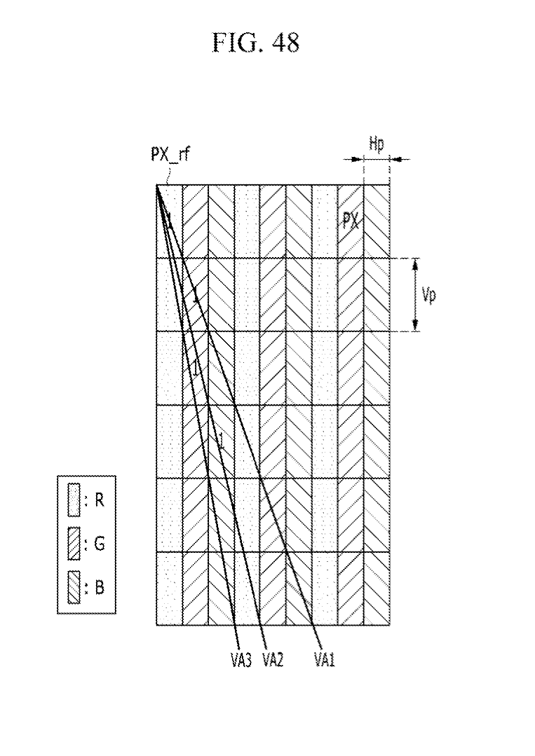

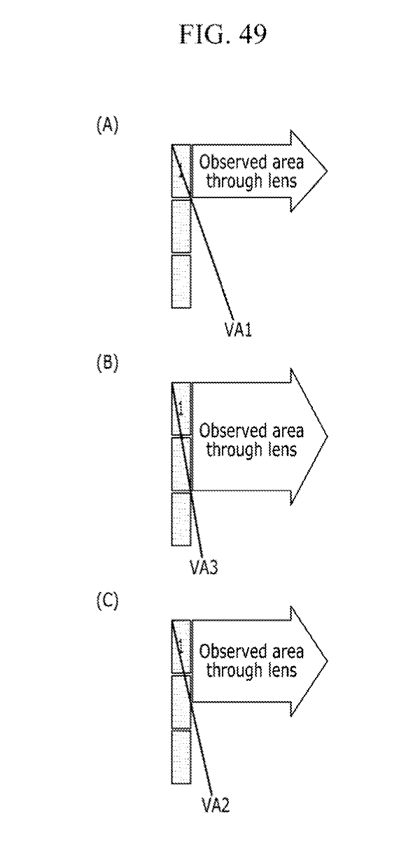

FIG. 48 shows several inclination angles of a view point division unit with respect to a display panel of a three-dimensional image display device according to an exemplary embodiment of the present disclosure, and FIG. 49 shows the primary color image observed at one view point for each view point division unit inclination angle shown in FIG. 48.

Referring to FIG. 48 and FIG. 49, in the case of the first inclination angle VA1, the second inclination angle VA2, and the third inclination angle VA3, the size of one primary color of one dot at one view point viewed through the lenticular lens or parallax barrier opening gradually increases with the sequence of the first inclination angle VA1, the second inclination angle VA2, and the third inclination angle VA3. That is, as the size of the view point division unit inclination angle increases, the image represented by one primary color of the viewed dot decreases such that the display quality of the 3D image may be improved.

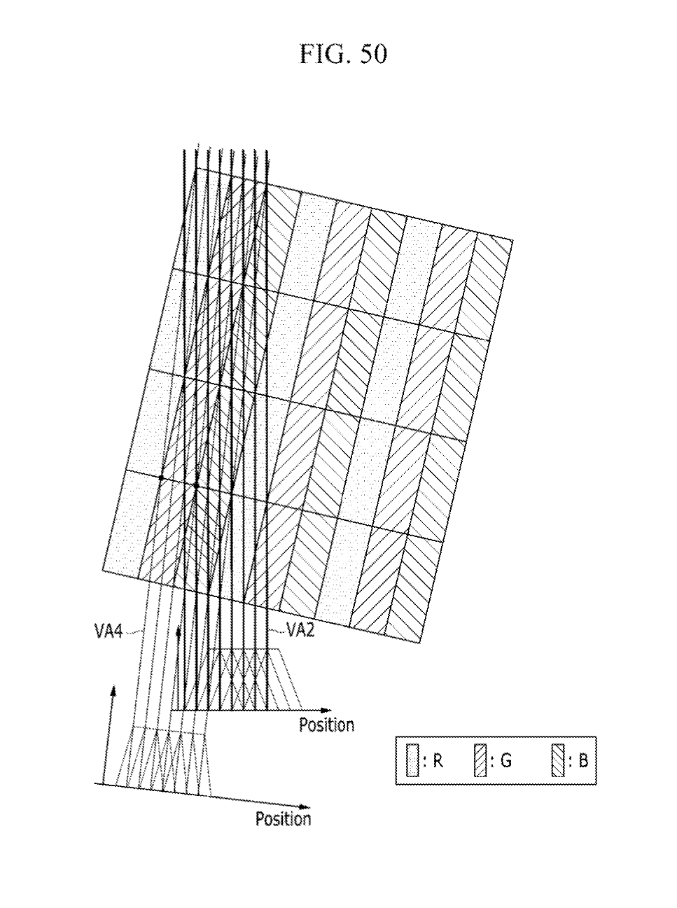

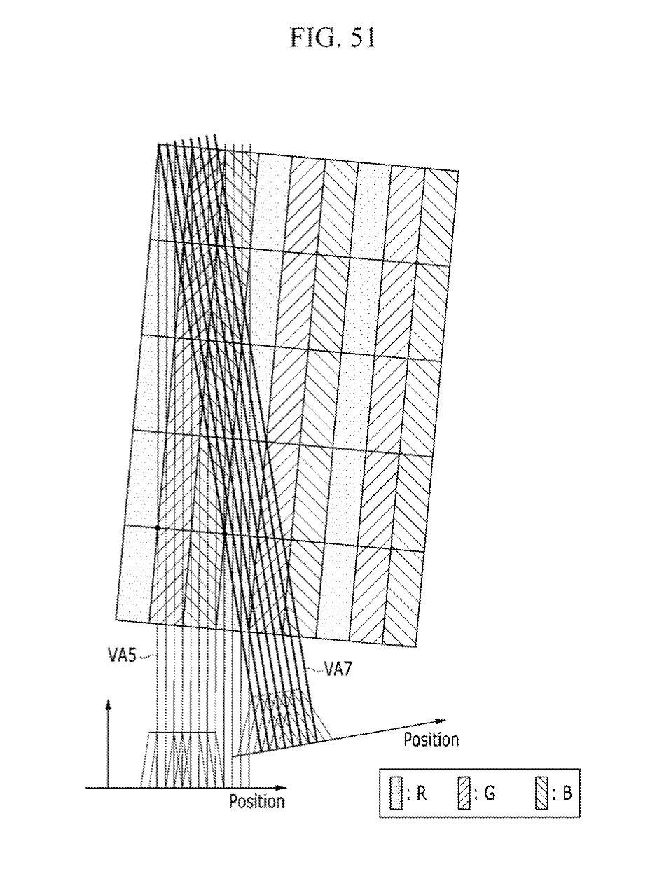

FIG. 50 and FIG. 51 show crosstalk for two inclination angles of a view point division unit with respect to a display panel of a three-dimensional image display device according to an exemplary embodiment of the present disclosure.

Referring to FIG. 50, for example, for the second inclination angle VA2 and the fourth inclination angle VA4, an amount of the crosstalk is the same at 200%. However, for the fourth inclination angle VA4, the images of the different primary colors are compensated by each other compared with the second inclination angle VA2 and are biased to one primary color, which can decrease a display quality of a three-dimensional image.

Referring to FIG. 51, for example, for the fifth inclination angle VA5 and the seventh inclination angle VA7, an amount of the crosstalk is the same at 300%. However, for the fifth inclination angle VA5, the images of the different primary colors are compensated by each other compared with the seventh inclination angle VA7 and are biased to one primary color, which can decrease a display quality of a three-dimensional image.

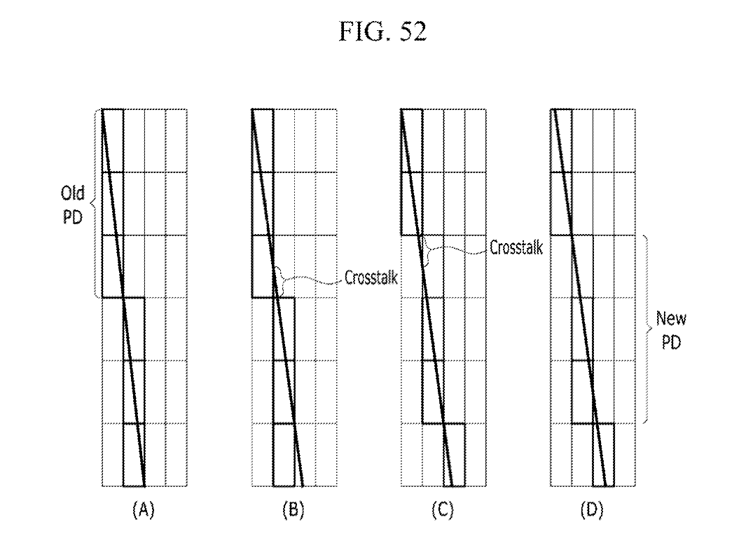

FIG. 52 shows a change of a proximity pixel as a function of a change of position for observing a three-dimensional image display device according to an exemplary embodiment of the present disclosure.

Finally, referring to FIG. 52, the pixels PX of the proximity pixel set PD may display images at different view points, and the same images may be displayed at the view points. However, as shown in FIG. 52 (A) to FIG. 52 (D), the state of the proximity pixel set PD changes according to a viewing position, and the pixels PX of the proximity pixel set PD may display images at the different view points to smooth the display of a three-dimensional image.

Accordingly, when the pixels PX of the proximity pixel set PD display the images at different view points, using the second inclination angle VA2 and the seventh inclination angle VA7, which have a large number of view points, may improve a display quality of a three-dimensional image.

While this disclosure has been described in connection with what is presently considered to be practical exemplary embodiments, it is to be understood that this disclosure is not limited to the disclosed embodiments, but, on the contrary, is intended to cover various modifications and equivalent arrangements included within the spirit and scope of the appended claims.

What is claimed is:

1. A three-dimensional image display device comprising:
a display panel that includes a plurality of pixels arranged in a matrix form and
a view point divider configured to divide a three-dimensional image displayed by the display panel into n view points, wherein n is a natural number greater than or equal to two and the view point divider includes a plurality of view point division units,
wherein each view point division unit is inclined at an inclination angle with reference to a column direction of the display panel,
the inclination angle satisfies
$$A = {tan}^{- 1} \frac{Hp \times a}{Vp \times b} , \\ 1 < a < b ,$$
wherein Hp is a pitch of a row direction of the pixels, Vp is a pitch of a column direction of the pixels, and a and b are natural numbers.

2. The three-dimensional image display device of claim 1, wherein
each pixel represents one color of a plurality of primary colors,
a width of the row direction of a region of a first pixel observed through the view point division unit is m×Hp/b, wherein m is a natural number, and
a second pixel next to the first pixel displayed by the same view point division unit as the first pixel displays the image at the same view point of the first pixel and is offset downward from the first pixel by b columns.

3. The three-dimensional image display device of claim 2, wherein
the plurality of view point division units includes a plurality of lenticular lenses.

4. The three-dimensional image display device of claim 3, wherein,
a focal distance F of the lenticular lens satisfies 1/D+1/G≠1/F,
wherein D is an optimal viewing distance from the view point divider for viewing the image of the display panel, and G is a distance between the lenticular lens and the display panel.

5. The three-dimensional image display device of claim 4, wherein,
if a focus position of the lenticular lens is positioned between the lenticular lens and the display panel, a focal distance Fs of the lenticular lens satisfies 1/D+(b*L+Hp)/b*L*G=1/Fs,
wherein L is a pitch of the lenticular lens.

6. The three-dimensional image display device of claim 4, wherein,
if a focus position of the lenticular lens is positioned outside an area between the lenticular lens and the display panel, a focal distance FL of the lenticular lens satisfies 1/D+(b*L−Hp)/b*L*G=1/FL,
wherein L is a pitch of the lenticular lens.

7. The three-dimensional image display device of claim 3, wherein
a=2 and b=3.

8. The three-dimensional image display device of claim 3, wherein
a=3 and b=4.

9. The three-dimensional image display device of claim 3, wherein
m is 1.

10. The three-dimensional image display device of claim 2, wherein
the view point divider includes a parallax barrier, and the view point division unit includes a plurality of openings of the parallax barrier arranged in a line.

11. The three-dimensional image display device of claim 10, wherein
the plurality of openings arranged in the line are inclined at the inclination angle.

12. The three-dimensional image display device of claim 11, wherein
a width W of each opening satisfies W=D×X/(D+G), where X=m×Hp/b,
wherein D is an optimal viewing distance from the view point divider for viewing the image of the display panel, and G is a distance between the parallax barrier and the display panel.

13. The three-dimensional image display device of claim 10, wherein
m is 1 or 2.

14. The three-dimensional image display device of claim 10, wherein
a=2 and b=3.

15. The three-dimensional image display device of claim 10, wherein
a=3 and b=4.

16. A three-dimensional image display device comprising:
a display panel that includes a plurality of pixels arranged in a matrix form wherein each pixel represents one color of a plurality of primary colors; and
a view point divider configured to divide a three-dimensional image displayed by the display panel into n view points, wherein n is a natural number greater than or equal to two and the view point divider includes a plurality of lenticular lenses, wherein a focal distance F of the lenticular lens satisfies 1/D+1/G≠1/F, wherein D is an optimal viewing distance from the view point divider for viewing the image of the display panel, and G is a distance between the lenticular lens and the display panel,
wherein a width of the row direction of a region of a first pixel observed through the lenticular lens is m×Hp/b, wherein Hp is a pitch of a row direction of the pixels and b and m are natural numbers, and
a second pixel next to the first pixel displayed by the same view point division unit as the first pixel displays the image at the same view point of the first pixel and is offset downward from the first pixel by b columns.

17. The three-dimensional image display device of claim 16, wherein each lenticular lens is inclined at an inclination angle with reference to a column direction of the display panel, the inclination angle satisfies
$$A = {tan}^{- 1} \frac{Hp \times a}{Vp \times b} , \\ 1 < a < b ,$$
wherein Vp is a pitch of a column direction of the pixels, and a and b are natural numbers.

18. The three-dimensional image display device of claim 16, wherein,
if a focus position of the lenticular lens is positioned between the lenticular lens and the display panel, a focal distance Fs of the lenticular lens satisfies 1/D+(b*L+Hp)/b*L*G=1/Fs,
wherein L is a pitch of the lenticular lens.

19. The three-dimensional image display device of claim 16, wherein, if a focus position of the lenticular lens is positioned outside an area between the lenticular lens and the display panel, a focal distance FL of the lenticular lens satisfies 1/D+(b*L−Hp)/b*L*G=1/FL,
wherein L is a pitch of the lenticular lens.

20. A three-dimensional image display device comprising:
a display panel that includes a plurality of pixels arranged in a matrix form each pixel represents one color of a plurality of primary colors; and
a view point divider configured to divide a three-dimensional image displayed by the display panel into n view points, wherein n is a natural number greater than or equal to two and the view point divider includes a parallax barrier that includes a plurality of openings arranged in a line,
wherein a width W of each opening satisfies W=D×X/(D+G),
wherein Hp is a pitch of a row direction of the pixels, D is an optimal viewing distance from the view point divider for viewing the image of the display panel, G is a distance between the parallax barrier and the display panel, where X=m×Hp/b, wherein b and m are natural numbers,
wherein a width of the row direction of a region of a first pixel observed through the lenticular lens is X, and
a second pixel next to the first pixel displayed by the same view point division unit as the first pixel displays the image at the same view point of the first pixel and is offset downward from the first pixel by b columns.

21. The three-dimensional image display device of claim 16, wherein each of plurality of openings is inclined at an inclination angle with reference to a column direction of the display panel, the inclination angle satisfies
$$A = {tan}^{- 1} \frac{Hp \times a}{Vp \times b} , \\ 1 < a < b ,$$
wherein Vp is a pitch of a column direction of the pixels, and a and b are natural numbers.
